(19) United States
(12) Patent Application Publication
(10) Pub. No.: US 2026/0121911 A1
(43) Pub. Date: Apr. 30, 2026

(54) SYSTEMS AND METHODS FOR DELIVERING NOTIFICATIONS IN REAL TIME

(71) Applicant: The PNC Financial Services Group, Inc., Pittsburgh, PA (US)

(72) Inventors: Ravi Ranganathan, Brunswick, OH (US); Jerold Xing, Richmond Hill (CA); Michael Nitsopoulos, Pittsburgh, PA (US)

(73) Assignee: The PNC Financial Services Group, Inc., Pittsburgh, PA (US)

(21) Appl. No.: 19/286,432

(22) Filed: Jul. 31, 2025

Related U.S. Application Data
(60) Provisional application No. 63/713,211, filed on Oct. 29, 2024.

(51) Int. Cl. H04L 41/0681

(52) U.S. Cl. CPC H04L 41/0681

(57) ABSTRACT

This application is directed to systems and methods for delivering notification for a user identification. An exemplary system may include memory configured to store instructions and at least one processor in electronic communication with the memory. The at least one processor is configured to execute the instructions to obtain a notification preference profile associated with the user identification, receive an alert trigger message associated with the user identification, determine whether to send the notification based on the alert trigger message and the notification preference profile, upon determining to send the notification, determine whether to send the notification in real time or at a scheduled time, and in response to determining to send the notification in real time: generate a real-time alert based on the notification preference profile and send a real-time notification message based on the real-time alert to a user device associated with the user identification.

### CROSS REFERENCE TO RELATED APPLICATIONS

The present application claims the benefit of priority to U.S. Provisional Application No. 63/713,211 , filed on Oct. 29, 2024, the entire contents of which are incorporated herein by reference.

### TECHNICAL FIELD

The present application relates to delivery of notifications to users and, more particularly, to systems and methods for delivering notifications in real time and/or at a specific time to user devices.

### BACKGROUND

When users register for service accounts on a typical service system, they may want to monitor the status of their account. Traditional service systems may provide status updates periodically, such as once a month. However, in many service industries, a user account's status can change frequently due to the user's actions, other users'actions, and/or the service system's operations. Users may want to receive status updates for certain changes as quickly as possible. Nonetheless, the periodic updates provided by traditional systems may not be timely enough. Therefore, it would be desirable to have systems and methods for delivering timely notifications to users.

In some service industries, a user account may be hacked in by an intruder. The intruder may alter data in the user account and/or operate on the service systems to transfer away intangible credits or assets from the user account. Since traditional systems may report such changes only after a period of time, users and service providers may not know or realize the changes to the user account or may not discover the intrusion early so that something can be done to minimize losses. Substantial losses may be caused by such an intrusion. The users and service providers have no chance to prevent losses or stop the intruder unless they receive alerts early. Thus, it would be desirable to have systems and methods for delivering notifications of the changes to the user account in a timely manner.

In some services, users may manage intangible credits or assets in their accounts based on statements on service systems the users saw last time.

Nonetheless, the intangible credits or assets in their accounts may change by operations of other users and/or service providers. For example, a service provider may take away a part of the intangible credits or assets as a service fee from an account. The user of the account may not know the reduced amount of the intangible credits or assets and make his own plan to transfer an amount larger than the reduced amount to another user's account. Such a transfer may fail and cause inconvenience for the user. Therefore, it would be desirable to have systems and methods for delivering timely notifications of such changes to users who may have concerns about the changes.

### SUMMARY

Consistent with embodiments of the present disclosure, a system for delivering notification for a user account may include a memory configured to store a plurality of instructions and at least one processor in electronic communication with the memory. The at least one processor may be configured to execute the plurality of instructions to: obtain a notification preference profile associated with the user identification; receive an alert trigger message associated with the user identification; determine whether to send the notification based on the alert trigger message and the notification preference profile; upon determining to send the notification, determine whether to send the notification in real time or at a specific time; and in response to determining to send the notification in real time: generate a real-time alert based on the notification preference profile; and send a real-time notification message based on the real-time alert to a user device associated with the user identification.

Also, consistent with embodiments of the present disclosure, there is provided a method for delivering notification for a user identification. The method includes obtaining a notification preference profile associated with the user identification; receiving an alert trigger message associated with the user identification; determining whether to send the notification based on the alert trigger message and the notification preference profile; upon determining to send the notification, determining whether to send the notification in real time or at a specific time; in response to determining to send the notification in real time: generating a real-time alert based on the notification preference profile; and sending a real-time notification message based on the real-time alert to a user device associated with the user identification.

In addition, consistent with embodiments of the present disclosure, there is provided a non-transitory computer-readable medium storing instructions which, when executed, cause at least one processor to perform operations for delivering notification for a user identification. The operations comprise: obtaining a notification preference profile associated with the user identification; receiving an alert trigger message associated with the user identification; determining whether to send the notification based on the alert trigger message and the notification preference profile; upon determining to send the notification, determining whether to send the notification in real time or at a specific time; and in response to determining to send the notification in real time: generating a real-time alert based on the notification preference profile; and sending a real-time notification message based on the real-time alert to a user device associated with the user identification.

Moreover, consistent with embodiments of the present disclosure, there is provided a system for delivering a notification for a user identification. The system includes a memory storing a plurality of instructions and at least one processor in electronic communication with the memory and configured to execute the plurality of instructions to: obtain a notification preference profile associated with the user identification; receive an alert trigger message associated with the user identification; determine whether to send the notification based on the alert trigger message and the notification preference profile; upon determining to send the notification, determine whether to send the notification in real time or at a specific time; and in response to determining to send the notification at the specific time: insert a specific-time alert into an alert data storage; determine to deliver the specific-time alert in the alert data storage based on the specific time; generate a specific-time notification message based on the specific-time alert and send the specific-time notification message to a user device associated with the user identification.

Also, consistent with embodiments of the present disclosure, there is provided a method for delivering notification for a user identification. The method includes obtaining a notification preference profile associated with the user identification; receiving an alert trigger message associated with the user identification; determining whether to send the notification based on the alert trigger message and the notification preference profile; upon determining to send the notification, determining whether to send the notification in real time or at a specific time; and In response to determining to send the notification at the specific time: inserting a specific-time alert into an alert data storage; determining to deliver the specific-time alert in the alert data storage based on the specific time; generating a specific-time notification message based on the specific-time alert; and sending the specific-time notification message to a user device associated with the user identification.

In addition, consistent with embodiments of the present disclosure, there is provided a non-transitory computer-readable medium storing instructions which, when executed, cause at least one processor to perform operations for delivering a notification for a user identification. The operations include: obtaining a notification preference profile associated with the user identification; receiving an alert trigger message associated with the user identification; determining whether to send the notification based on the alert trigger message and the notification preference profile; upon determining to send the notification, determining whether to send the notification in real time or at a specific time; in response to determining to send the notification at the specific time: inserting a specific-time alert into an alert data storage; determining to deliver the specific-time alert in the alert data storage based on the specific time; generating a specific-time notification message based on the specific-time alert; sending the specific-time notification message to a user device associated with the user identification.

Furthermore, consistent with embodiments of the present disclosure, there is provided a service system with alert notifications. The service system includes at least one memory storing a plurality of instructions and at least one processor in electronic communication with the at least one memory. The at least one processor configured to execute the plurality of instructions to detect an event associated with a user identification; generate an alert trigger for the event; obtain an alert configuration associated with the user identification; generate an alert candidate based on the alert trigger and the alert configuration; obtain an alert template based on the alert candidate; generate an alert message based on the alert candidate and the alert template; and deliver the alert message to a user device associated with the user identification.

Also, consistent with embodiments of the present disclosure, there is provided a method for delivering alert notifications. The method includes detecting an event associated with a user identification; generating an alert trigger for the event; obtaining an alert configuration associated with the user identification; generating an alert candidate based on the alert trigger and the alert configuration; obtaining an alert template based on the alert candidate; generating an alert message based on the alert candidate and the alert template; and delivering the alert message to a user device associated with the user identification.

In addition, consistent with embodiments of the present disclosure, there is provided a non-transitory computer-readable medium storing instructions which, when executed, cause at least one processor to perform operations for delivering notifications. The operations include detecting an event associated with a user identification; generating an alert trigger for the event; obtaining an alert configuration associated with the user identification; generating an alert candidate based on the alert trigger and the alert configuration; obtaining an alert template based on the alert candidate; generating an alert message based on the alert candidate and the alert template; and delivering the alert message to a user device associated with the user identification.

Furthermore, embodiments of the present disclosure may also include computer systems, apparatus, processes, and computer programs recorded on one or more computer storage devices, each configured to perform the actions disclosed in the present disclosure.

It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A illustrates an exemplary problem with an out-of-date record of a service.

FIG. 1B illustrates an exemplary delivery of an update on the record of the service in real time, according to some embodiments of the present disclosure.

FIG. 2A illustrates a usage scenario of an exemplary notification delivery system, consistent with disclosed embodiments.

FIG. 2B is a functional diagram of a usage scenario of an exemplary notification delivery system, consistent with disclosed embodiments.

FIG. 2C is a block diagram of an exemplary notification delivery system, consistent with disclosed embodiments.

FIG. 3A illustrates exemplary alert preferences for receiving notification messages, consistent with disclosed embodiments.

FIGS. 3B, 3C, and 3D illustrate exemplary notification messages via exemplary short message service (SMS), push, and email channels, consistent with disclosed embodiments.

FIG. 4 in two sheets illustrates exemplary operations of an exemplary event-driven alert notification in real time, consistent with disclosed embodiments.

FIG. 5 in two sheets illustrates exemplary operations of an exemplary ad hoc application programming interface (API) call-driven notification in real time, consistent with disclosed embodiments.

FIG. 6 illustrates an exemplary method for delivering a notification in real time, consistent with disclosed embodiments.

FIG. 7 in two sheets illustrates exemplary operations of an exemplary scheduled notification, consistent with disclosed embodiments.

FIG. 8 illustrates an exemplary method for delivering a notification at a specific time, consistent with disclosed embodiments.

FIG. 9 in two sheets illustrates a functional diagram of an exemplary service system with real-time and scheduled-time notification functions, consistent with disclosed embodiments.

FIG. 10 is an exemplary alert administration console user interface of an exemplary notification delivery system, consistent with disclosed embodiments.

FIG. 11 illustrates an exemplary method for delivering real-time and scheduled-time notifications by an exemplary service system, consistent with disclosed embodiments.

### DETAILED DESCRIPTION

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

A user may register a user account for accessing a plurality of services on a service system. In many services, various events associated with the user account may occur because of the user's actions, other users'actions, and/or operations of the service system. The events may include, for example, changes to records and/or statuses of the user account. When some events associated with the user account occur, the user may want to receive an update on the user account in a timely manner. For example, when an event occurs and results in a material change to the user account, the user may expect to receive a notification message in real time. When an event occurs and updates information about an aspect of the user account that the user considers helpful, the user may expect to receive a notification message at a scheduled time. If an event occurs and updates insignificant information about the user account, the user may expect to receive such a notification message periodically at a fixed time.

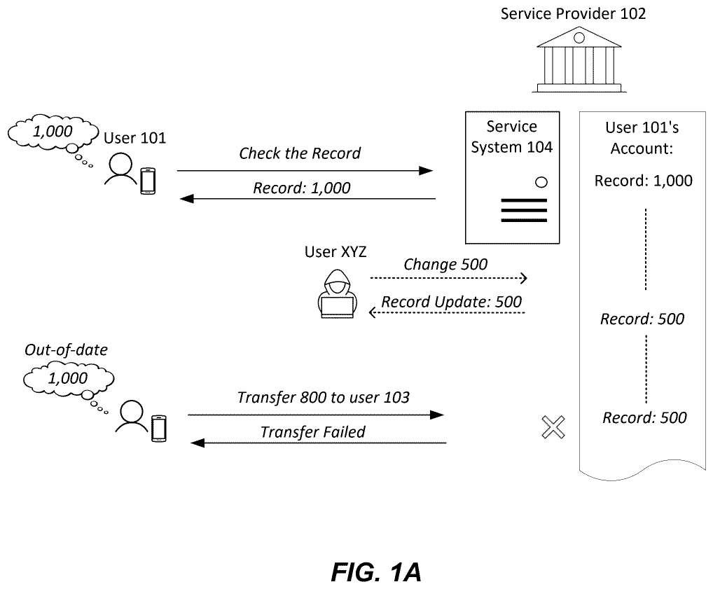

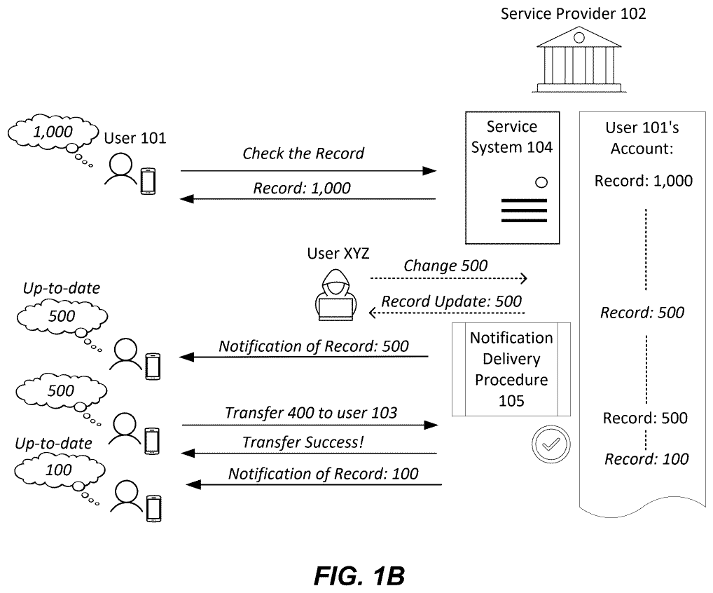

FIG. 1A illustrates an exemplary problem with an out-of-date record of a service. As shown in FIG. 1A, user 101 may access a service provided by a service system 104 of a service provider 102. Service system 104 may be configured to provide the service to users, including user 101, and maintain a user account of user 101 with a plurality of records. One of the records may indicate that user 101 has 1,000 units. The units may represent any physical or virtual subjects, such as products, goods, money, stock shares, cryptocurrency, and credit points.

As shown in FIG. 1A, user 101 may check a current amount of the record with service system 104 and receive a response indicating 1,000 units in user 101's account. User 101 may then remember that he or she has 1,000 in his or her account. Later, a user XYZ may cause a change of 500 in the record in user 101's account. For example, user XYZ may be a creditor and request service system 104 to take away 500 units from user 101's account. As another example, user XYZ may be an administrator of service 104 and operate on service system 104 to take away 500 units as an annual service fee. The record of user 101's account may then be only 500 units.

However, user 101 may still think he or she has 1,000 units, which may have been an out-of-date record. With the out-of-date information, user 101 may operate on service system 104 to transfer 800 units to another person. Because the record in his or her account has only 500 units at the time, user 101's operation would fail. This may cause inconvenience and potential problems for user 101 when he or she manages the record in the account because he or she has no up-to-date information. In some situations, if user XYZ is an intruder and operates on service system 104 to take away 500 units for no reason, user 101 may not know this until he or she logs in on service system 104 next time, which may be a couple of weeks later. User 101 may not have a chance to report this issue immediately to prevent the loss. Since this issue is not immediately reported, service provider 102 may not discover the intrusion by an intruder and may not be able to discover potential security problems and/or fraud issues in service system 104. For example, service system 104 may have security loopholes and therefore was hacked in by the intruder. As another example, an intruder may obtain user 101's account and password by an unjust means and log in to take away the 500 units. If user 101 does not report the issue immediately, service provider 102 and other users may further suffer from similar losses, security problems, and/or fraud issues.

FIG. 1B illustrates an exemplary delivery of an update on the record of the service in real time, according to some embodiments of the present disclosure. As shown in FIG. 1B, service system 104 may be configured to perform a notification delivery procedure 105 to obtain a notification preference profile associated with user 101, receive an alert trigger message (e.g., a change in the record to 500 units) associated with user 101, determine whether to send the notification based on the alert trigger message and the notification preference profile, upon determining to send the notification, determine whether to send the notification in real time or at a specific time, and in response to determining to send the notification in real time: generate a real-time alert based on the notification preference profile and send a real-time notification message based on the real-time alert to a user device associated with user 101.

When service system 104 has a preference of user 101 for receiving a notification message in real time, a change in the record of user 101 occurs. For example, when user XYZ causes a change of 500 units to the record in user 101's account, service system 104 may be configured to send a real-time notification indicating a record of 500 units to user 101 even though the change is not caused by user 101. User 101 may therefore have up-to-date information that the record of his or her account is 500 units on service system 101. With this up-to-date information about his or her account, user 101 may not transfer 800 units to user 103, as shown in FIG. 1A. Instead, user 101 may transfer 400 units to user 103 from his or her account, which may be a successful transfer. Service system 104 may be configured to send another notification of the record of 100 to user 101. With real-time notification messages, user 110 may have up-to-date information to manage his account correctly and efficiently.

In some situations, if user XYZ is an intruder and operates on service system 104 to take away 500 units for no reason, user 101 may know this issue immediately after receiving the real-time notification. User 101 may report this issue to service provider 102 and may prevent his or her account from unauthorized access. Thus, with the notification of the record in real time, user 101 may have up-to-date information to ensure security of his or her account.

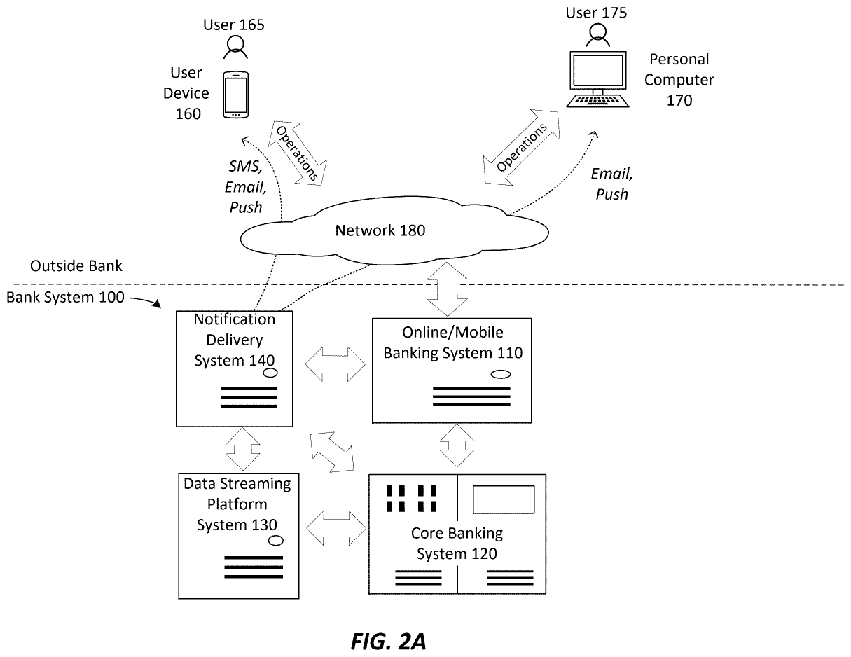

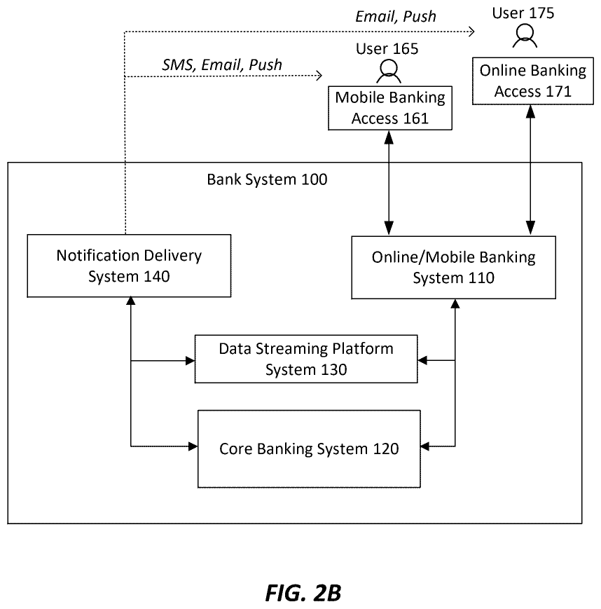

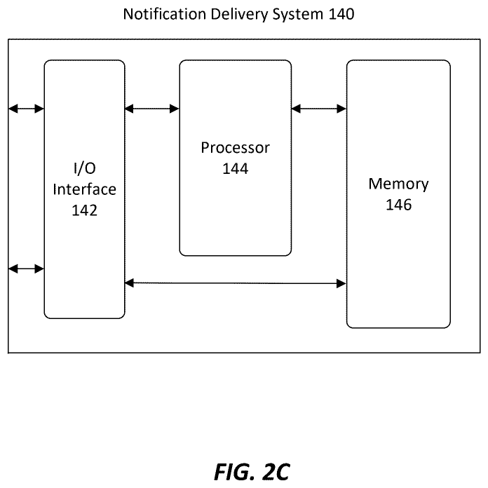

FIG. 2A illustrates a usage scenario of an exemplary notification delivery system 140, consistent with disclosed embodiments. As shown in FIG. 2A, a bank system 100 may include an online/mobile banking system 110, a core banking system 120, a data streaming platform system 130, and notification delivery system 140 communicatively connected with each other. Notification delivery system 140 may be configured to perform notification delivery procedure 105 (FIG. 1B). These systems may be implemented by one or more computer systems, each having one or more processors and memories to perform the operations described below.

Online/mobile banking system 110 may be configured to provide various banking services to bank customers, such as users 165 and 175. For example, online/mobile banking system 110 may be configured to provide various mobile banking services to users 165 and 175 via a network 180. Network 180 may be, for example, the Internet, a telecommunication network, a mobile communication network, a local area network, or a bank's private network.

Core banking system 120 may be implemented by, for example, a mainframe and a system of record. Core banking system 120 may be configured for at least one of accounting, customer relationship management, risk management, day-to-day transactions, account management, or reporting. For example, core banking system 120 may be configured to operate with online/mobile banking system 110 to make various transactions for users 165 and 175, such as disbursement of payments and recording and updating transaction information for users 165's and 175's accounts in the system of record. The system of record may be an authoritative data source for a given data element or piece of information in bank system 100.

Data streaming platform system 130 may be configured to publish data, events, and/or changes within bank system 100, to allow other functional components of bank system 100 to receive the published data, events, and/or changes, and some of the function components may react and/or adjust their operations. For example, data streaming platform system 130 may be configured to publish events occurring in the system of record related to banking accounts of users 165 and 175 to allow notification delivery system 140 and/or online/mobile banking system 110 to react and/or adjust their operations.

Notification delivery system 140 may be configured to monitor some or all updates related to users of banking system 100 and determine whether to notify a user in real time or at a scheduled time. For example, notification delivery system 140 may be configured to listen to some events related to bank accounts of users 165 and 175 and send them notification messages to inform them of the events.

As shown in FIG. 1, users 165 and 175 may access online/mobile banking system 110 through network 180. For example, user 165 may operate on a mobile banking application on a user device 160 to access online/mobile banking system 110 through network 180. User 165 may make a wire transfer from his or her bank account to the bank account of user 175. After user 165 confirms the wire transfer on online/mobile banking system 110, online/mobile banking system 110 may be configured to operate, together with core banking system 120, to transfer an amount of money to the bank account of user 175. Core banking system 120 may be configured to update the balance in the bank account of user 165 and publish a balance update within bank system 100 via data streaming platform system 130.

Because the balance of the bank account may be critical information for user 165, user 165 may set a preference for receiving notification of such an update.

Notification delivery system 140 may be configured to listen to the published balance update and to send SMS, email, and/or push notification messages in a timely manner to user device 160 via network 180. After user 165 receives the notification message indicating the updated balance, user 165 may be able to confirm the wire transfer and review the balance. The notification message may keep user 165 informed of the status of his or her bank account and provide a favorable user experience to user 165.

After user 165 confirms the wire transfer, core banking system 120 may be configured to update the balance in the bank account of user 175 and publish a balance update within bank system 100 via data streaming platform system 130. User 175 may consider the balance of his or her bank account critical information and set a preference for receiving notification of any update on the balance of the bank account. Notification delivery system 140 may be configured to listen to the published balance update and to send email and/or push notification messages in a timely manner to user device 170 via network 180. After user 175 receives the notification message indicating the updated balance, user 175 may know the wire transfer and the new balance. The notification message may keep user 175 informed of the status of his or her bank account and provide a favorable user experience to user 175.

In the above example, both users 165 and 175 may receive notification messages of the balance updates after they set the preferences. Notification delivery system 140 may be configured to listen to published events based on their preferences. In other words, notification delivery system 140 may be configured to send notification messages based on the preferences of users 165 and 175. Users 165 and 175 may set different preferences for different updates, one or more types of messages, and in real time or at a scheduled time. By providing users 165 and 175 with notification messages in real time or at the scheduled time according to their individual preferences, notification delivery system 140 may assist users 165 and 175 to have timely notifications. In some situations, if an error occurs, users 165 and 175 may know the error early upon receiving the notifications. This early discovery of the error may help to resolve the error promptly and avoid inducing other errors.

FIG. 2B is a functional diagram of the usage scenario of exemplary notification delivery system 140 in FIG. 2A, consistent with disclosed embodiments. As shown in FIG. 2B, bank system 100 may include online/mobile banking system 110, core banking system 120, data streaming platform system 130, and notification delivery system 140 communicatively connected with each other, and operate as described with respect to FIG. 2A. As shown in FIG. 2B, online/mobile banking system 110 may be configured to provide a mobile banking access 161 as an access portal for user 165 and/or an online banking access 171 as an access portal for user 175. Notification delivery system 140 may be configured to listen to updates and/or events published by data streaming platform system 130 and provided from online/mobile banking system 110 and core banking system 120. Notification delivery system 140 may be configured to determine whether to deliver notification of an event or update to user device 160 for user 165 and/or personal computer 170 for user 175 in real time or at a scheduled time according to individual preferences of users 165 and 175, as described with reference to FIG. 2A.

FIG. 2C is a block diagram of exemplary notification delivery system 140 in FIG. 2A, according to some embodiments of the present disclosure. As shown in FIG. 2C, notification delivery system 140 includes an input/output (I/O) interface 142, a processor 144, and a memory 146. Processor 144 may be coupled to I/O interface 142 to input and/or output data from/to external components, such as online/mobile banking system 110, core banking system 120, and/or data streaming platform system 130 (FIG. 2A). Processor 144 may also be coupled to memory 146 to access data for delivering notification to a user device. These elements of notification delivery system 140 may be configured to transfer data and send or receive instructions and signals between or among each other.

I/O interface 142 may be coupled with processor 144 to receive input data, events, and/or messages from and output data and messages to online/mobile banking system 110, core banking system 120, and/or data streaming platform system 130. In some embodiments, I/O interface 142 may include one or more wireline and/or wireless network interfaces, such as WLAN, Wi-Fi, and/or mobile communication network interfaces. Notification delivery system 140 may be configured to transmit and receive data and messages to and from online/mobile banking system 110, core banking system 120, and/or data streaming platform system 130 via the one or more WLAN, Wi-Fi, and/or mobile communication network interfaces.

Processor 144 may include any appropriate type of one or more general-purpose or special-purpose microprocessors, digital signal processors, artificial intelligence processors, and/or microcontrollers. Processor 144 may be configured by one or more programs stored in memory 146 to perform operations with respect to the systems, devices, and methods illustrated and described herein.

Memory 146 may include any appropriate type of mass storage provided to store any type of information that processor 144 may need to operate. Memory 146 may include one or more of a volatile or non-volatile, magnetic, semiconductor, tape, optical, removable, non-removable, or other type of storage device or tangible (i.e., non-transitory) computer-readable medium including, but not limited to, a read-only memory (ROM), a flash memory, a dynamic random-access memory (RAM), and a static RAM. Memory 146 may be configured to store one or more programs for execution by processor 144 for monitoring synthetic transactions and handling errors by runbooks, as disclosed herein. Memory 146 may be further configured to store information and data received from online/mobile banking system 110, core banking system 120, and/or data streaming platform system 130.

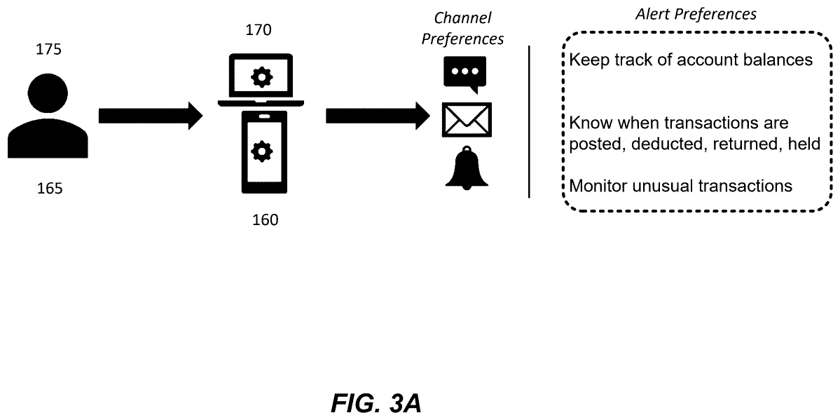

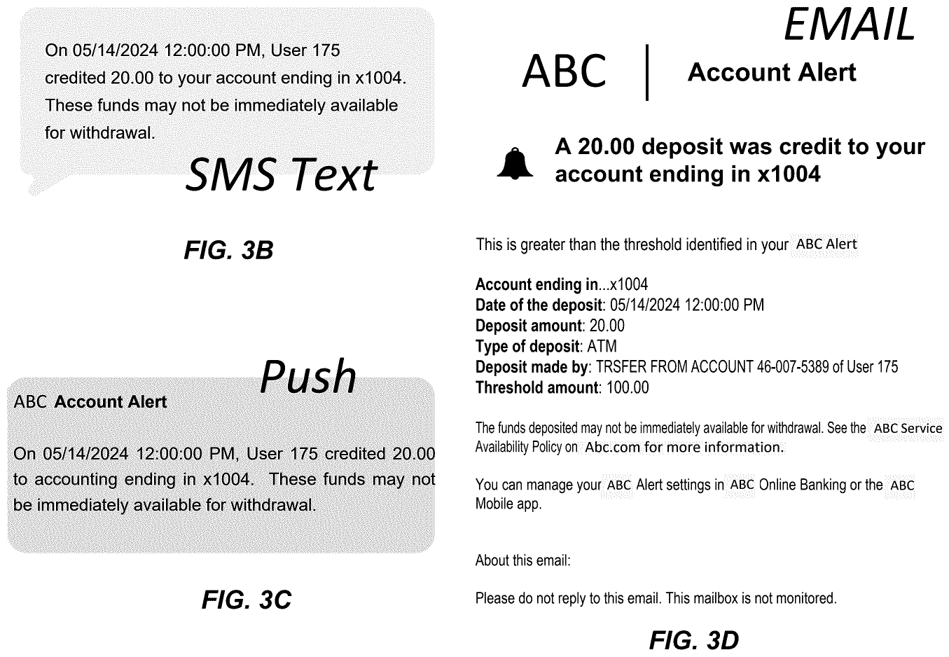

FIG. 3A illustrates exemplary alert preferences for receiving notification messages, consistent with disclosed embodiments. For example, users 165 and 175 may operate user devices 160 and 170 to set up their alert preferences to keep track of account balances, know when transactions are posted, deducted, returned and held, and monitor unusual transactions, as shown in FIG. 3A. Users 165 and 175 may also set up his or her notification channel preference as a short message service (SMS) text message, a push message on a mobile banking application, and/or an email to receive alert notifications for these events. To receive the SMS text message and the email, users 165 and 175 may provide his or her cell phone number and email address in her preference setting. By setting up the alert preferences for these events and channel preference, users 165 and 175 may receive notification messages on user devices 160 and 170 from notification delivery system 140 (FIG. 2A).

In some embodiments, user 165 or 175 may log in on online/mobile banking system 110 and select specific notification profiles from their available list of active accounts with the bank. The notification preferences of users 165 and 175 may indicate at least one of notification channels, including an SMS text notification channel, a push notification channel, and an email notification channel. Users 165's and 175's selections of the notification channels may be considered their channel preferences.

In some embodiments, a notification preference profile may include a subscription status and an indication of at least one of a short message service text notification channel, a push notification channel, or an email notification channel. For example, user 165's notification preference profile may include whether user 165 has subscribed to a real-time notification service and which one of a short message service text notification channel, a push notification channel, or an email notification channel, or any combination thereof, user 165 would like to receive as a real-time notification.

In some embodiments, a notification preference profile includes preference data. The preference data may include at least one of a subscription status, a subscribed notification channel, contact information, or a threshold amount. For example, user 175's notification preference profile may include preference data. The preference data may include whether user 175 subscribes to a real-time or scheduled notification service. The preference data may also include which one of a short message service text notification channel, a push notification channel, an email notification channel, or any combination thereof, user 175 would like to receive a notification. The preference data may also include user 175's cell phone number or email for receiving the notification. In some embodiments, the preference data may also include a threshold amount for an account balance that user 175 would like to receive a notification if his or her account balance is lower than the threshold account.

In some embodiments, a notification preference profile of a user may include a preference code. The preference code may correspond to at least one of a short message service text notification channel, a push notification channel, or an email notification channel. For example, user 165's notification preference profile may include a preference code 001, which indicates that user 165 prefers to receive a real-time SMS text message.

In some embodiments, a notification preference profile of a user may be associated with the user or an account of the user. For example, user 165's notification preference profile may be associated with user 165. In such a manner, user 165's notification preference profile may be applied to all accounts of user 165. Alternatively, user 165's notification preference profile may be associated with one of the accounts of user 165. In such a manner, user 165's notification preference profile may be applied to the one of the accounts of user 165.

In some embodiments, an alert triggering event may be tied to a user (e.g., a customer) or an account of the user as two preference levels. The preference may depend on an alert-triggering event. If the alert triggering event requires a notification to a user that he or she has changed his or her online banking settings, the alert triggering event may be tied to the user. If the alert triggering event requires notifying a user of a balance change or a transaction, the alert triggering event is tied to an account.

FIGS. 3B, 3C, and 3D illustrate exemplary notification messages via exemplary SMS, push, and email channels, consistent with disclosed embodiments. FIG. 3B illustrates an SMS notification message that notifies user 165 of a change in his or her bank account ending in x1004 because user 175 credited $20.00 into the account. For sending such an SMS notification message, notification delivery system 140 may be configured to access user 165's alert preferences (e.g., FIG. 3A) and cellular number in a preference profile associated with the bank account ending in x1004. Notification delivery system 140 may be configured to listen to an event related to user 165's bank account ending in x1004 and check and confirm that the event of the account balance is one of the alert preferences of user 165 (FIG. 3A). Notification delivery system 140 may then be configured to generate the SMS notification message in FIG. 3B and send it to user 165's cellular number in the preference profile.

FIG. 3C illustrates a push notification message to a bank mobile application on a user device with the same notification content as that in FIG. 3B. For example, after checking and confirming that the event of the account balance is one of the alert preferences of user 165 (FIG. 3A), notification delivery system 140 may be configured to check that the preference profile associated with the bank account indicates a channel preference for a push notification message. After learning the channel preference, notification delivery system 140 may be configured to generate and push the notification message in FIG. 3C to the mobile bank application on user device 160 (FIG. 2A).

FIG. 3D illustrates a notification email with a similar notification content as that in FIG. 3B. As shown in FIG. 3D, the email may include additional information, such as a type of deposit, a source account, and a threshold amount. For sending the email, after checking and confirming that the event of the account balance is one of the alert preferences of user 165 (FIG. 3A), notification delivery system 140 may be configured to check that the preference profile associated with the bank account indicates a channel preference for an email notification message. After learning the channel preference, notification delivery system 140 may be configured to generate and send the email notification message in FIG. 3D to an email address in the preference profile associated with the bank account ending in x1004.

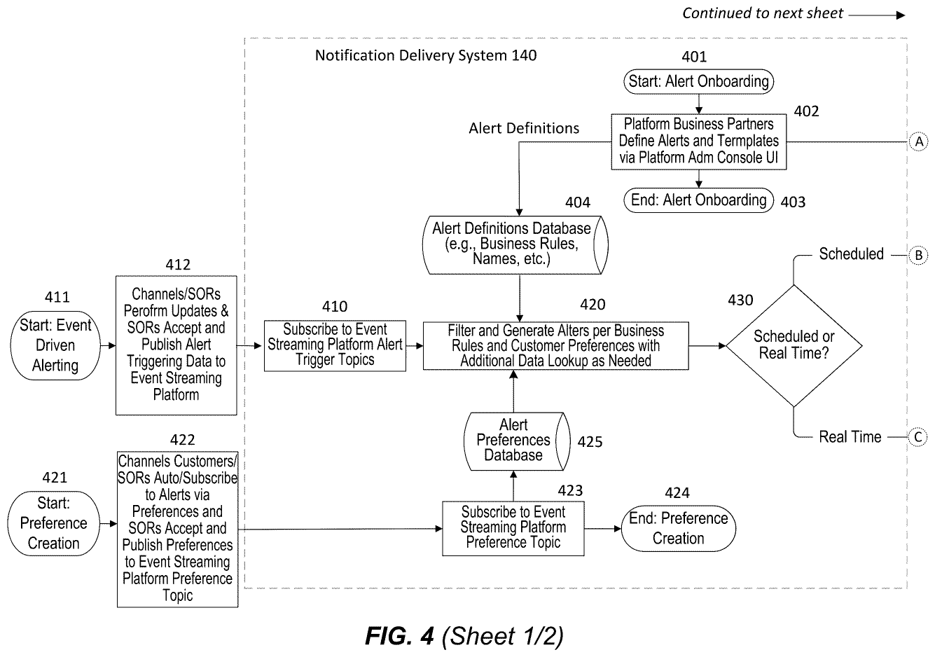

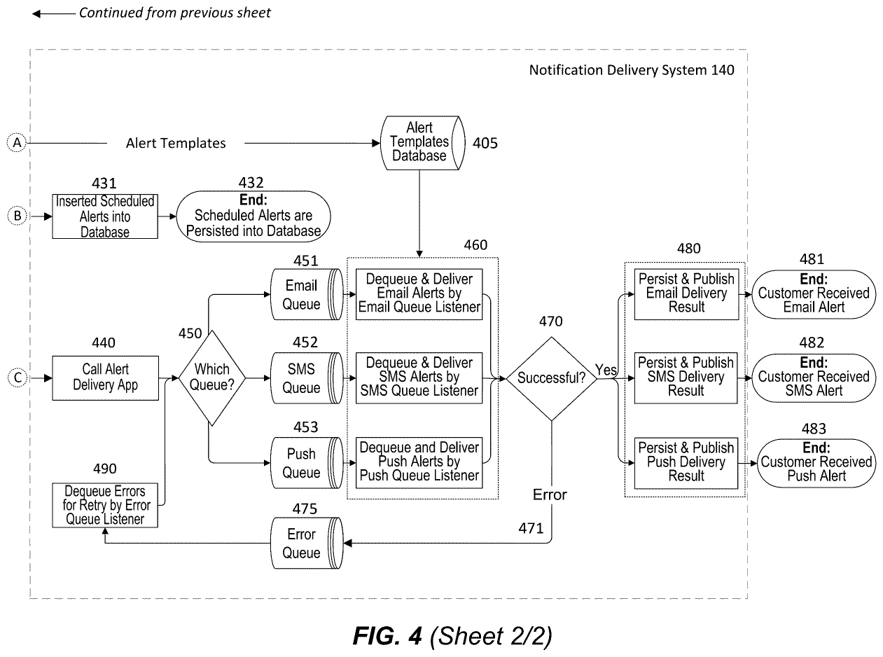

FIG. 4 in two sheets illustrates exemplary operations of an exemplary event-driven alert notification, consistent with disclosed embodiments. Notification delivery system 140 (FIGS. 2A, 2B, and 2C) may be configured to practice operations described herein with reference to FIG. 4.

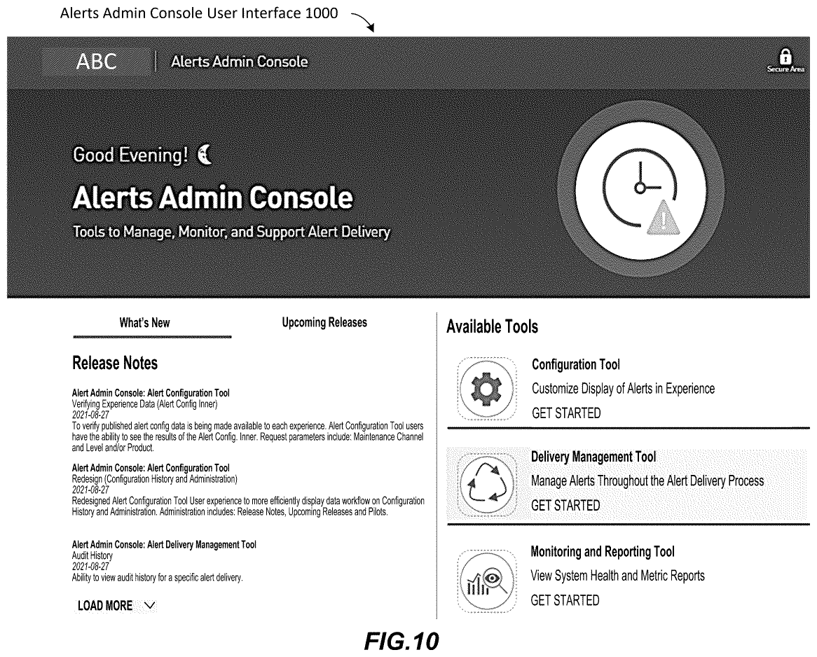

A notification delivery system administrator, for example, a platform business partner, may define alerts and alert templates and configure notification delivery system 140, via an alert administration console user interface (UI) (FIG. 10), to have access to the alert definitions and alert templates. As shown in FIG. 4, notification delivery system 140 may be configured to perform alert onboarding (step 401), configure alert definitions and templates (step 402), and complete alert onboarding (step 403).

Step 401 includes performing an alert onboarding process. The alert onboarding process may refer to a process performed by notification delivery system 140 to set up an alert's definition, one or more rules for managing the alert, and system parameters for the alert. For example, notification delivery system 140 may be configured to perform an alert onboarding process by receiving alert definitions and alert templates via the alert administration console UI (FIG. 10).

Step 402 includes configuring alert definitions and templates. For example, notification delivery system 140 may be configured to store the alert definitions, business rules for the alert notification, and/or names of notification senders and recipients in an alert definitions database 404. Alert definition database 404 may include a server with one or more hard drives configured to store and retrieve the alert definitions, business rules for the alert notification, and/or names of notification senders and recipients. Alert definition database 404 may also include a database management system configured to manage operations on alert definition database 404, such as defining, creating, querying, updating, and administering data. Alert definition database 404 may also include a database application configured to allow notification delivery system 140 or other systems to interact with alert definition database 404 for data entry and/or data analysis.

Notification delivery system 140 may also be configured to store the alert templates in an alert template database 405. Alert template database 405 may include a server with one or more hard drives configured to store a plurality of alert templates. Alert template database 405 may also include a database management system to manage its operations and a database application to allow notification delivery system 140 or other systems to interact with alert template database 405. The alert templates may be associated with the alert definitions. For example, some alert templates may include contents to address various types of alerts, such as account balance updates, account display mode updates, and abnormal transactions. An account display mode may correspond to one layout of the user interface of the account. Different display modes may correspond to different layouts of the user interfaces. In some embodiments, the alert templates may be associated with notification channels, such as SMS, email, and push channels (FIG. 3A). For example, some alert templates may contain formats of SMS messages, notification emails, and push messages.

Step 403 includes completing the alert onboarding process. For example, after storing the alert definitions in alert definition database 404 and the alert templates in alert template database 405, notification delivery system 140 may be configured to end the alert onboarding process. In some embodiments, ending the alert onboarding process may refer to storing a new alert within the system, which can now detect and notify users regarding additional alerts.

Alert definitions database 404 may be implemented by a data storage system and configured to store the alert definitions, such as business rules, names of alerts, and names of users. Notification delivery system 140 may access alert definitions database 404 to obtain the business rules and/or names of alerts and users. The alert definitions may include business rules and names.

Alert template database 405 may be implemented by a data storage system and configured to store the alert templates, such as email, SMS, and push message templates.

After the alert onboarding process, notification delivery system 140 may be configured to obtain information about the alert definitions in alert definitions database 404 and alert templates in alert template database 405 for delivering alert notification messages to users of bank system 100.

A user (e.g., users 165 and 175) may set up his or her notification preferences on online/mobile banking system 110 (FIGS. 2A and 2B) or ask a notification delivery system administrator to set up the notification preferences for them. After receiving the user's notification preferences, bank system 100 (FIGS. 2A and 2B) may be configured to start a preference creation process (step 421) and establish associations among users, system of records, and subscriptions to alerts and publish user preferences to a data streaming platform (step 422), as shown in FIG. 4. Notification delivery system 140 may be configured to subscribe to preference topics of users on the data streaming platform (step 423) and complete the preference creation process (step 424), as shown in FIG. 4.

Step 421 includes performing a preference creation process. For example, when users 165 and 175 set up their notification preferences, core banking system 120 and data streaming platform system 130 (FIGS. 2A and 2B) may be configured to receive the notification preferences of user 165 and 175.

Step 422 includes establishing associations between users, system of records, and subscriptions to alerts and publishing user preferences to a data streaming platform. The existence of the associations may allow an event associated with a user's account to be reported to notification delivery system 140. In some embodiments, the association may be used for sending an alert. For example, core banking system 120 and data streaming platform system 130 (FIGS. 2A and 2B) may be configured to establish associations between bank accounts of users 165 and 175, topics of events in system of records, topics of events on data streaming platform system 130, and topics subscribed in notification preferences profiles of users 165 and 175. The topics of the events may include any changes in account balances, posted, deducted, returned, and held transactions, unusual transactions (FIG. 3A). By the associations, the system of record in core banking system 120 may be configured to publish events of the topics subscribed to by users 165 and 175 when they occur, to data streaming platform system 130 (FIG. 2A). Data streaming platform system 130 (FIG. 2A) may be configured to stream the events of the topics on the data streaming platform to allow notification delivery system 130 to receive them.

In addition, the system of records may also be configured to publish the alert preferences of users 165 and 175 to data streaming platform system 130 (FIG. 2A). Data streaming platform system 130 (FIG. 2A) may be configured to stream preference topics in the alert preferences to allow other systems in banking system 100 to learn and record their alert preferences.

Step 423 includes subscribing to preference topics of users on the data streaming platform. For example, notification delivery system 140 may be configured to subscribe on data streaming platform system 130 (FIG. 2A) for the topics of the events in users 165's and 175's preferences, such as changes in account balances, posted, deducted, returned, and held transactions, or unusual transactions (FIG. 3A). Notification delivery system 140 may also be configured to store the user's alert preferences in an alert preferences database 425.

Step 424 includes completing the preference creation process. For example, notification delivery system 140 may be configured to end the preference creation process after storing the alert preferences of users 165 and 175 in alert preferences database 425.

Alert preferences database 425 may be implemented by a data storage system and configured to store the alert preferences of users 165 and 175, such as user-preferred events for sending notifications, preferences for receiving real-time and/or scheduled notifications, channel preferences (SMS messages, push messages, or emails), and/or conditions for sending notifications. When the channel preferences include an SMS channel, alert preferences database 425 may also be configured to store a cell phone number for sending SMS notification messages. When the channel preferences include an email channel, alert preferences database 425 may also be configured to store an email address for sending email notification messages.

After banking system 100 stores the alert definitions and templates (step 402) and establishes the topics of events according to users'alert preferences, notification delivery system 140 may be configured to listen to any alert event that is associated with the banking account of the users and is within their alert preferences. An event associated with a user's account may occur in bank system 100. Bank system 100 may be configured to perform an event driven alerting process (step 411) and publish the event to the data streaming platform (step 412).

Step 411 includes performing an event driven alerting process. For example, user 175 may transfer $20.00 from his or her bank account to user 165's bank account ending in x1004. This transfer may cause a change in the account balance of user 165. Because user 165's alert preferences include tracking account balances, the system of record may be configured to initiate an event driven alerting process by preparing an event indicating the change in the account balance of user 165.

Step 412 includes publishing the event to the data streaming platform. For example, the system of record may be configured to update the account balance of user 165 and publish the event on the data streaming platform. Data streaming platform system 130 may be configured to stream the event on the platform to allow notification delivery system 140 to receive it.

After notification delivery system 140 stores the alert preferences of users 165 and 175 in alert preferences database 425 (step 423), notification delivery system 140 may be configured to obtain a notification preference profile associated with a user account. For example, notification delivery system 140 may be configured to retrieve the alert preferences of user 165 from alert preference database 425 as a notification preference profile of the bank account ending in x1004.

To provide an alert notification to user 165 in real time or at a specific time, as shown in FIG. 4, notification delivery system 140 may be configured to subscribe to alert trigger topics on the event streaming platform based on the notification preference profile associated with the user account (step 410), filter and generate alerts based on service rules and user preferences (step 420), determine whether to send a notification in real time or at a scheduled time (step 430), in response to determining to send the notification in real time, call an alert delivery application to generate a real-time alert (step 440), determine to add the real-time alert in one of alert queues (step 450), dequeue and deliver the real-time alert (step 460), determine whether the delivery is successful (step 470), persist and publish a successful delivery result if the delivery is successful (step 480), and end the notification process (steps 481-483). If the delivery is not successful, notification delivery system 140 may be configured to add the real-time alert in an error queue (step 471) and re-deliver the real-time alert (step 490). In response to determining to send the notification at a scheduled time in step 430, notification delivery system 140 may be configured to insert a scheduled alert in a specific-time alert database (step 431) and end the notification process (step 432).

Step 410 includes subscribing to alert trigger topics on the event streaming platform based on the notification preference profile associated with the user account. For example, the notification preference profile associated with user 165's bank account ending in x1004 may include keeping track of account balances (FIG. 3A). The preference of keeping track of account balances may indicate a subscription to an alert trigger topic of any change in balances of user 165's bank account ending in x1004. Notification delivery system 140 may be configured to subscribe to those alert trigger topics related to changes in balances of user 165's bank account ending in x1004.

Step 420 includes filtering and generating alerts based on service rules and user preferences. For example, as shown in FIG. 4, notification delivery system 140 may be configured to filter a plurality of events of various alert trigger topics on the data streaming platform to obtain an event of one of the alert trigger topics subscribed for user 165's bank account ending in x1004. This event may indicate a change in the balance of user 165's bank account.

After obtaining the event of one of the subscribed alert trigger topics, notification delivery system 140 may be configured to determine whether to deliver an alert for the event based on service rules and user preferences. For example, bank system 100 may have a first service rule that a balance of an account could only be provided to an account owner, and a second rule that a balance of an account could only be requested by an owner. The first and second rules may be stored as the business rules in alert definitions database 404 (step 402). Because the event may be an alert trigger message for delivering a notification to user 165, who is the owner of the account ending in x1004, the first rule may be met. Also, because user 165 may be the owner of the account ending in x1004 and may have made a request for a balance of the account when user 165 sets up his or her alert preferences (FIG. 3A), the second rule may also be met. In addition, the event, indicating the change in the balance of user 165's bank account, may match user 165's preferences because one of the alert preferences of user 165 is keeping track of account balances (FIG. 3A). The alert preferences of user 165 may be stored in alert preferences database 425 (step 423). Notification delivery system 140 may be configured to obtain the first and second service rules from alert definitions database 404 and user 165's alert preferences from alert preferences database 425. Because the event may match the first and second service rules and user 165's alert preferences, notification delivery system 140 may be configured to determine to deliver an alert for the event.

If the event does not match one of the service rules and/or user 165's alert preferences, notification delivery system 140 may be configured to determine not to deliver an alert for the event. For example, if an event indicating a change in the balance of a bank account of user 175 is filtered out as an alert trigger message for user 165, notification delivery system 140 may be configured to determine not to deliver an alert for the event because user 165 is not the owner of the account and the event may not match the first and second rules.

In some embodiments, notification delivery system 140 may be configured to execute an alert candidate generator program to receive events that may need to send alert notifications, bundle required data to be used in the alert into an alert candidate and pass the alert candidate to an alert generator. The alert candidate may include a bundle of data created when the alert candidate generator first hears an alert trigger. Notification delivery system 140 may be configured to execute a rules engine (e.g., an application program) to evaluate the alert candidate to determine if it should be delivered to the user. The rules engine may be configured to implement a plurality of rules to determine whether an alert candidate should be sent to the alert delivery application to deliver to the user. For example, one of the rules may require that a balance of an account could only be provided to an account owner. If the alert candidate's destination is an account of an owner, notification delivery system 140 may be configured to execute the rules engine to check that the alert candidate's destination is the account owner and proceed.

Step 430 may include determining whether to send a notification in real time or at a scheduled time. For example, as shown in FIG. 4, upon determining to send the notification to user 165, notification delivery system 140 may be configured to determine whether to notify user 165 in real time or at a scheduled time based on the notification preference profile associated with user 165's account ending in x1004. The notification preference profile, set up by user 165, may include a preference to be notified in real time by an SMS message and an email. Notification delivery system 140 may be configured to determine to send the notification in real time based on the user 165's notification preference profile.

Step 431 includes inserting a scheduled alert in a specific-time alert database in response to determining to send the notification at a scheduled time in step 430. For example, user 165 may set up a change of a display mode on online/mobile banking system 110, to be notified at a scheduled time, such as in a daily notification at 23:00. A display mode on online/mobile banking system 110 may correspond to one layout of a user interface of online/banking system 110. Different display modes may correspond to different layouts of the user interface. The notification preference profile, set up by user 165, may include a preference to be notified in a schedule time of 23:00 by an email for a change to a display mode on online/mobile banking system 110. If notification delivery system 140 filters out an event of a change to the display mode, notification delivery system 140 may be configured to insert a scheduled alert at 23:00 in a scheduled alert database based on user 165's notification preference profile.

Step 432 includes ending the notification process. For example, after inserting the scheduled alert at 23:00 in the scheduled alert database, notification delivery system 140 may be configured to end the notification for the event.

Step 440 includes calling an alert delivery application to generate a real-time alert in response to determining to send the notification in real time. For example, as shown in FIG. 4, in response to determining to send the notification in real time, notification delivery system 140 may be also configured to call an alert delivery application to generate a real-time alert based on user 165's notification preference profile. The notification preference profile of user 165 may include the preference to be notified in real time by both an email and an SMS message. Notification delivery system 140 may then be configured to call the alert delivery application to generate a first real-time alert for an email channel and a second real-time alert for an SMS channel.

Step 450 includes determining whether to add the real-time alert in one of alert queues. For example, as shown in FIG. 4, notification delivery system 140 may support three alert channels, including the email, SMS, and push channels. Notification delivery system 140 may be configured to establish an email queue 451, an SMS queue 452, and a push queue 453 to keep email alerts, SMS alerts, and push alerts, respectively, before these alerts are delivered. In the example described in step 440, after generating the first real-time alert for the email channel and the second real-time alert for the SMS channel, notification delivery system 140 may be configured to add the first real-time alert in email queue 451 and the second real-time alert in SMS queue 452. Email queue 451 may be a queue configured to store alert candidates that will be sent by email. The alert candidates in email queue 451 may be retrieved and sent by in first-in-first-out manner. SMS queue 452 may be a queue configured to store alert candidates that will be sent by SMS messages. The alert candidates in SMS queue 452 may be retrieved and sent by in first-in-first-out manner. Push queue 453 may be a queue configured to store alert candidates that will be sent by push messages to user applications on user devices. The alert candidates in push queue 453 may be retrieved and sent by in first-in-first-out manner.

Step 460 includes dequeuing and delivering the real-time alert. For example, as shown in FIG. 4, notification delivery system 140 may establish email queue 451, SMS queue 452, and push queue 453, as described in the example in step 450. After adding the first real-time alert in email queue 451 and the second real-time alert in SMS queue 452, notification delivery system 140 may be configured to dequeue the first real-time alert from email queue 451. Notification delivery system 140 may also be configured to assemble an email, such as the email in FIG. 3D, based on the first real-time alert and alert templates database 405. Notification delivery system 140 may be further configured to deliver the email to, for example, user 165.

Notification delivery system 140 may also be configured to dequeue the second real-time alert from SMS queue 452. Notification delivery system 140 may be configured to assemble an SMS message, such as the SMS text in FIG. 3B, based on the second real-time alert and alert templates database 405. Notification delivery system 140 may be further configured to deliver the SMS message to, for example, user 165.

Step 470 includes determining whether the delivery is successful. For example, as shown in FIG. 4, after notification delivery system 140 delivers the email, notification delivery system 140 may be configured to determine whether the delivery is successful based on whether notification delivery system 140 receives a bounce back email. The bounce back email may indicate that the email for the notification was not sent correctly for a reason, such as an erroneous email address or a receiving email server has no response. If notification delivery system 140 does not receive a bounce back email, notification delivery system 140 may be configured to determine that the delivery is successful. If notification delivery system 140 receives the bounce back email, notification delivery system 140 may be configured to determine that the delivery is not successful.

Step 480 includes persisting and publishing a successful delivery result if the delivery is successful. For example, as shown in FIG. 4, if the delivery is successful, notification delivery system 140 may be configured to persist and publish a successful delivery result in bank system 100. If the delivery is not successful, notification delivery system 140 may be configured to add the delivery result to an error queue 475. As an example, if the SMS message for user 165 is not delivered successfully, notification delivery system 140 may be configured to receive a delivery result indicating an error. Notification delivery system 140 may be configured to add the delivery result of the real-time SMS message for user 165 to error queue 475.

After persisting and publishing the successful delivery result, notification delivery system 140 may be configured to end the notification process for the event. For example, notification delivery system 140 may be configured to end the notification process with a record that user 165 has received an email alert (step 481), an SMS alert (step 482), and/or a push alert (step 483), as shown in FIG. 4.

Step 471 includes adding the real-time alert to an error queue if the delivery is not successful. For example, if the delivery of the SMS message for user 165 is not successful, notification delivery system 140 may be configured to add the second real-time alert to an error queue 475.

Step 490 includes re-delivering the real-time alert. For example, notification delivery system 140 may be configured to dequeue the second real-time alert from error queue 475 and re-deliver the second real-time alert by operations in steps 450, 460, 470, and 480, as described above with reference to FIG. 4.

In some embodiments, notification delivery system 140 may be configured to re-send the real-time notification message after a period of time, such as one, three, or five minutes. In some embodiments, notification delivery system 140 may be configured to deliver the real-time notification message a number of times. The number of times for delivering the real-time notification message may be included in user 165's or user 175's notification preference profile.

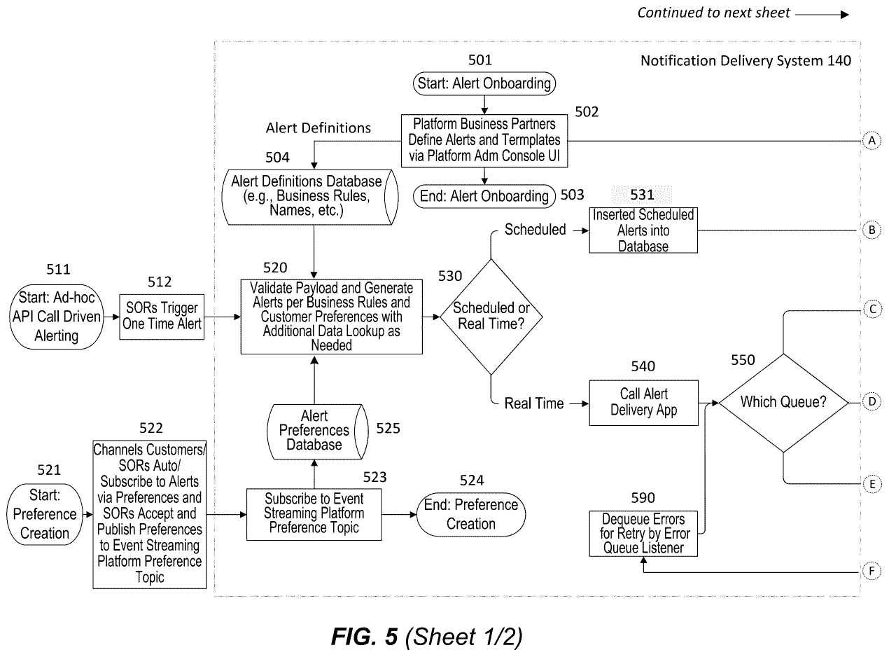

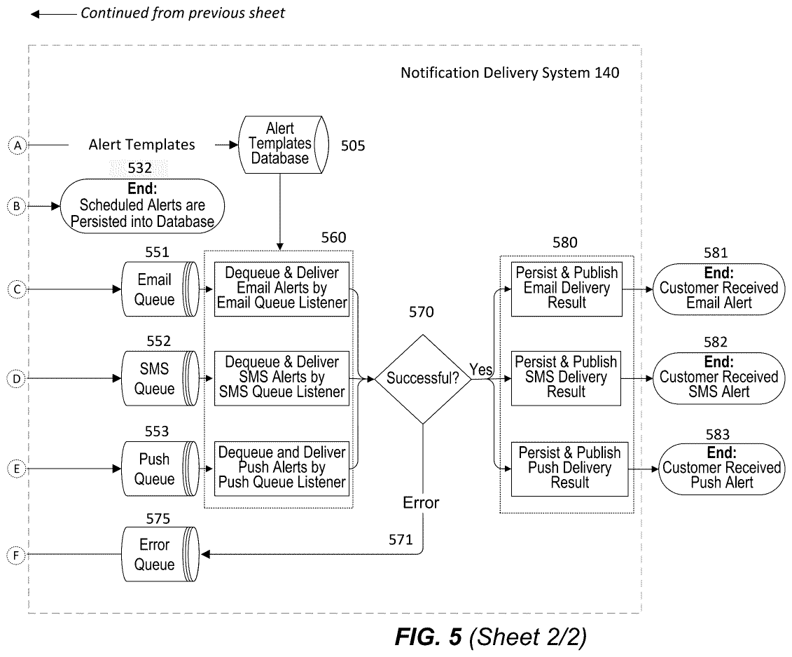

FIG. 5 in two sheets illustrates exemplary operations of an exemplary ad hoc application programming interface (API) call-driven notification, consistent with disclosed embodiments. Notification delivery system 140 (FIGS. 2A and 2B) may be configured to practice operations in FIG. 5.

Notification delivery system 140 may be configured to receive alert definitions and alert templates via an alert administration console user interface (FIG. 10). As shown in FIG. 5, notification delivery system 140 may be configured to start an alert onboarding process (step 501), configure alert definitions and templates (step 502), and complete alert onboarding (step 503).

Step 501 includes performing an alert onboarding process. The alert onboarding process may refer to a process performed by notification delivery system 140 to set up an alert's definition, one or more rules for managing the alert, and system parameters for the alert. For example, notification delivery system 140 may be configured to perform alert onboarding process by receiving alert definitions and alert templates via the alert administration console UI (FIG. 10).

Step 502 includes configuring alert definitions and templates. For example, notification delivery system 140 may be configured to store the alert definitions, business rules for the alert notification, and/or names of notification senders and recipients in an alert definitions database 504. Alert definition database 504 may include a server with one or more hard drives configured to store and retrieve the alert definitions, business rules for the alert notification, and/or names of notification senders and recipients. Alert definition database 504 may also include a database management system configured to manage operations on alert definition database 504, such as defining, creating, querying, updating, and administering data. Alert definition database 504 may also include a database application configured to allow notification delivery system 140 or other systems to interact with alert definition database 504 for data entry and/or data analysis.

Notification delivery system 140 may also be configured to store the alert templates in an alert template database 505. Alert template database 505 may include a server with one or more hard drives configured to store a plurality of alert templates.

Alert template database 505 may also include a database management system to manage its operations and a database application to allow notification delivery system 140 or other systems to interact with alert template database 505. The alert templates may be associated with the alert definitions. For example, some alert templates may include contents to address various types of alerts, such as account balance updates, account display mode updates, and abnormal transactions. An account display mode may correspond to one layout of the user interface of the account. Different display modes may correspond to different layouts of the user interfaces. In some embodiments, the alert templates may be associated with notification channels, such as SMS, email, and push channels (FIG. 3A). For example, some alert templates may contain formats of SMS messages, notification emails, and push messages.

Step 503 includes completing the alert onboarding process. For example, after storing the alert definitions in alert definition database 504 and the alert templates in alert template database 505, notification delivery system 140 may be configured to end the alert onboarding process.

Alert definitions database 504 may be implemented by a data storage system and configured to store the alert definitions, such as business rules, names of alerts, and names of users. Notification delivery system 140 may access alert definitions database 504 to obtain the business rules and/or names of alerts and users. The alert definitions may include business rules and names.

Alert template database 505 may be implemented by a data storage system and configured to store the alert templates, such as email, SMS, and push message templates.

After the alert onboarding process, notification delivery system 140 may be configured to obtain information about the alert definitions in alert definitions database 504 and alert templates in alert template database 505 for delivering alert notification messages to users of bank system 100.

A user, for example, user 165 or 175 (FIGS. 2A, 2B, and 3A), may set up his or her notification preferences on online/mobile banking system 110. Bank system 100 (FIGS. 2A and 2B) may be configured to start a preference creation process (step 521) and establish associations among users, system of records, and subscriptions to alerts and publish user preferences to a data streaming platform (step 522), as shown in FIG. 5. Notification delivery system 140 may be configured to subscribe to preference topics of users on the data streaming platform (step 523) and complete the preference creation process (step 524), as shown in FIG. 5.

Step 521 includes performing a preference creation process. For example, when users 165 and 175 set up their notification preferences, core banking system 120 and data streaming platform system 130 (FIGS. 2A and 2B) may be configured to receive the notification preferences of user 165 and 175.

Step 522 includes establishing associations between users, system of records, and subscriptions to alerts and publishing user preferences to a data streaming platform. The existence of the associations may allow an event associated with a user's account to be reported to notification delivery system 140. In some embodiments, the association may be used for sending an alert. For example, core banking system 120 and data streaming platform system 130 (FIGS. 2A and 2B) may be configured to establish associations between bank accounts of users 165 and 175, topics of events in system of records, topics of events on data streaming platform system 130, and topics subscribed to in notification preferences profiles of users 165 and 175. The topics of the events may include any changes in account balances, posted, deducted, returned, and held transactions, unusual transactions (FIG. 3A). By the associations, the system of record in core banking system 120 may be configured to publish events of the topics subscribed by users 165 and 175 when they occur, to data streaming platform system 130 (FIG. 2A). Data streaming platform system 130 (FIG. 2A) may be configured to stream the events of the topics on the data streaming platform to allow notification delivery system 130 to receive them.

In addition, the system of records may also be configured to publish the alert preferences of users 165 and 175 to data streaming platform system 130 (FIG. 2A). Data streaming platform system 130 (FIG. 2A) may be configured to stream preference topics in the alert preferences to allow other systems in banking system 100 to learn and record their alert preferences.

Step 523 includes subscribing to preference topics of users 165 and 175 on the data streaming platform. For example, notification delivery system 140 may be configured to subscribe on data streaming platform system 130 (FIG. 2A) for the topics of the events in users 165's and 175's preferences, such as changes in account balances, posted, deducted, returned, and held transactions, unusual transactions (FIG. 3A). Notification delivery system 140 may also be configured to store users 165's and 175's alert preferences in an alert preferences database 525.

Step 524 includes completing the preference creation process. For example, notification delivery system 140 may be configured to end the preference creation process after storing the alert preferences of users 165 and 175 in alert preferences database 525.

Alert preferences database 525 may be implemented by a data storage system and configured to store the alert preferences of users 165 and 175, such as user-preferred events for sending notifications, preferences for receiving real-time and/or scheduled notifications, channel preferences (SMS messages, push messages, or emails), and/or conditions for sending notifications. When the channel preferences include an SMS channel, alert preferences database 525 may also be configured to store a cell phone number for sending SMS notification messages. When the channel preferences include an email channel, alert preferences database 525 may also be configured to store an email address for sending email notification messages.

After banking system 100 stores the alert definitions and templates (step 502) and establishes the topics of events according to users'alert preferences, notification delivery system 140 may be configured to listen to any alert event that is associated with the banking account of the users and is within their alert preferences. An event associated with a user's account may occur in bank system 100. The system of record of bank system 100 may be configured to publish the event on the data streaming platform. After receiving the event published on the data streaming platform, notification delivery system 140 may be configured to perform an event-driven alerting process, as described above with reference to FIG. 4.

Alternatively, when an event may not be published on the data streaming platform and/or not related to a subscription option on a user alert preference, the system of record of bank system 100 may be configured to send a one-time alert for an account user without going through the data streaming platform. Bank system 100 may be configured to start an ad-hoc application programming interface (API) call-driven alerting process (step 511), and the system of record may be configured to trigger a one-time alert for the event (step 512).

Step 511 includes starting an ad-hoc API call-driven alerting process. For example, user 165 may transfer $100.00 from his or her bank account to user 175's bank account. This transfer may cause a change in the account balance of user 175. The system of record of bank system 100 may inadvertently encounter an unknown issue and may not be able to update the balance of user 175's bank account. Even though user 175's alert preferences include tracking account balances, such an inadvertent event is not within the scope of user 175's alert preferences. The system of record may be configured to start an ad-hoc API call-driven alerting process by preparing a one-time alert indicating the inadvertent event to user 175.

Step 512 includes triggering a one-time alert for the event. For example, the system of record may be configured to trigger a one-time alert for the inadvertent event of not being able to update the balance of user 175's account. Specifically, the system of record may be configured to initiate an API call for the one-time alert to notification delivery system 140.

To provide an alert notification based on the one-time alert to user 175 in real time or at a specific time, as shown in FIG. 5, notification delivery system 140 may be configured to validate a payload of an API call for an one-time alert and generate an alert per business rules and user preferences with additional data lookup as needed (step 520), determine whether to send a notification in real time or at a scheduled time (step 530), in response to determining to send the notification in real time, call an alert delivery application to generate a real-time alert (step 540), determine to add the real-time alert in one of alert queues (step 550), dequeue and deliver the real-time alert (step 560), determine whether the delivery is successful (step 570), persist and publish a successful delivery result if the delivery is successful (step 580), and end the notification process (steps 581-583). If the delivery is not successful, notification delivery system 140 may be configured to add the real-time alert in an error queue (step 571) and re-deliver the real-time alert (step 590). In response to determining to send the notification at a scheduled time in step 530, notification delivery system 140 may be configured to insert a scheduled alert in a specific-time alert database (step 531) and end the notification process (step 532).

Step 520 includes validating a payload of an API call for a one-time alert and generating an alert per business rules and user preferences with additional data lookup as needed. For example, notification delivery system 140 may be configured to validate a payload of the one-time alert in the API call from the system of record. As an example, notification delivery system 140 may validate correctness of, for example, user 175's name, identification number, and account number in the payload of the one-time alert. After verifying the correctness of the payload, notification delivery system 140 may be configured to determine whether to deliver the one-time alert based on service rules and user 175's preferences in a similar manner as described above in step 420 (FIG. 4). When notification delivery system 140 determines to deliver the one-time alert, notification delivery system 140 may be configured to generate an alert per business rules stored in alert definitions database 504 and user 175's preferences stored in alert preference database 525.

Step 530 includes determining whether to send a notification in real time or at a scheduled time, For example, notification delivery system 140 may be configured to determine whether to notify user 175 in real time or at a scheduled time based on the notification preference profile associated with user 175's account in a similar way as described above in step 430 for user 165 with reference to FIG. 4.

Step 531 includes inserting a scheduled alert in a specific-time alert database in response to determining to send the notification at a scheduled time in step 530. For example, user 175 may set up an alert about a system issue to be notified at a scheduled time, such as in a daily notification at 8:00. The notification preference profile, set up by user 175, may include a preference to be notified in a schedule time of 8:00 by an SMS message for a system issue. Notification delivery system 140 may be configured to insert a scheduled alert at 8:00 in a scheduled alert database based on user 165's notification preference profile.

Step 532 includes ending the notification process. For example, after inserting the scheduled alert at 8:00 in the scheduled alert database, notification delivery system 140 may be configured to temporarily end the notification process for the one-time alert before the scheduled time arrives.

Step 540 includes calling an alert delivery application to generate a real-time alert in response to determining to send the notification in real time. For example, as shown in FIG. 5, in response to determining to notify user 175 in real time, notification delivery system 140 may be configured to call an alert delivery application program to generate a real-time alert based on user 175's notification preference profile in a similar way as described above for user 165 in step 440 with reference to FIG. 4.

Step 550 includes determining to add the real-time alert in one of alert queues. For example, as shown in FIG. 5, notification delivery system 140 may support three alert channels, including the email, SMS, and push channels. Notification delivery system 140 may be configured to establish an email queue 551, an SMS queue 552, and a push queue 553 to keep email alerts, SMS alerts, and push alerts, respectively, before these alerts are delivered. In the example described in step 540, after generating the real-time alert for the SMS channel, notification delivery system 140 may be configured to add the real-time alert to SMS queue 552. Email queue 551 may be a queue configured to store alert candidates that will be sent by email. The alert candidates in email queue 551 may be retrieved and sent by in first-in-first-out manner. SMS queue 552 may be a queue configured to store alert candidates that will be sent by SMS messages. The alert candidates in SMS queue 552 may be retrieved and sent by in first-in-first-out manner. Push queue 553 may be a queue configured to store alert candidates that may be sent by push messages to user applications on user devices. The alert candidates in push queue 553 may be retrieved and sent by in first-in-first-out manner.

Step 560 includes dequeuing and delivering the real-time alert. For example, after adding the real-time alert to SMS queue 552, notification delivery system 140 may be configured to dequeue the real-time alert from SMS queue 552. Notification delivery system 140 may be configured to assemble an SMS message, such as an SMS text similar to the SMS text in FIG. 3B, based on the real-time alert and the alert templates stored in alert templates database 505. Notification delivery system 140 may be further configured to deliver the SMS message to user 175.

Step 570 includes determining whether the delivery is successful. For example, as shown in FIG. 5, after notification delivery system 140 delivers the SMS message, notification delivery system 140 may be configured to determine whether the delivery is successful based on whether notification delivery system 140 receives an error message. The error message may indicate that the SMS message for the notification was not sent correctly for a reason, such as an erroneous phone number. If notification delivery system 140 does not receive the error message, notification delivery system 140 may be configured to determine that the delivery is successful. If notification delivery system 140 receives the error message, notification delivery system 140 may be configured to determine that the delivery is not successful.

Step 580 includes persisting and publishing a successful delivery result if the delivery is successful. For example, as shown in FIG. 5, if the delivery is successful, notification delivery system 140 may be configured to persist and publish a successful delivery result in bank system 100. If the delivery is not successful, notification delivery system 140 may be configured to add the delivery result to an error queue 575. As an example, if the SMS message for user 175 is not delivered successfully, notification delivery system 140 may be configured to receive a delivery result indicating an error. Notification delivery system 140 may be configured to add the delivery result of the real-time SMS message for user 175 to error queue 575.

After persisting and publishing the successful delivery result, notification delivery system 140 may be configured to end the notification process for the event. For example, notification delivery system 140 may be configured to end the notification process with a record that user 175 has received an email alert (step 581), an SMS alert (step 582), and/or a push alert (step 583), as shown in FIG. 5.

Step 571 includes adding the real-time alert in an error queue if the delivery is not successful. For example, if the delivery of the SMS message for user 175 is not successful, notification delivery system 140 may be configured to add the real-time alert in error queue 575.

Step 590 includes re-delivering the real-time alert. For example, notification delivery system 140 may be configured to dequeue the real-time alert from error queue 575 and re-deliver the second real-time alert by operations in steps 550, 560, 570, and 580, as described above with reference to FIG. 5.

In some embodiments, notification delivery system 140 may be configured to re-send the real-time notification message after a period of time, such as one, three, or five minutes. In some embodiments, notification delivery system 140 may be configured to deliver the real-time notification message a number of times. The number of times for delivering the real-time notification message may be included in user 165's or user 175's notification preference profile.

In some embodiments, one or more of the embodiments and examples described above for the exemplary event-driven alert notification with reference to FIG. 4 may be applied to the exemplary ad hoc API call-driven notification described above with reference to FIG. 5.

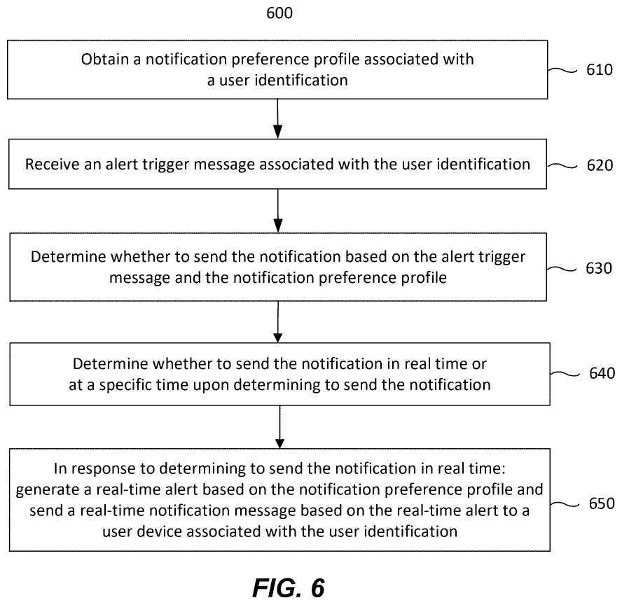

FIG. 6 illustrates an exemplary method 600 for delivering a notification in real time, consistent with disclosed embodiments. Notification delivery system 140 may be configured to perform method 600 for delivering a notification for a user account. Method 600 may include obtaining a notification preference profile associated with the user identification (step 610), receiving an alert trigger message associated with the user identification (step 620), determining whether to send the notification based on the alert trigger message and the notification preference profile (step 630), determining whether to send the notification in real time or at a specific time upon determining to send the notification (step 640), and in response to determining to send the notification in real time: generating a real-time alert based on the notification preference profile and sending a real-time notification message based on the real-time alert to a user device associated with the user identification (step 650).

Step 610 includes obtaining a notification preference profile associated with the user identification. For example, notification delivery system 140 may be configured to obtain user 165's alert preference associated with the user 165's account ending in x1004 from alert preferences database 425 (FIG. 4). The user 165's account ending in x1004 may be an example of a user identification of user 165. User 165's alert preferences may include user-preferred events for sending notifications, preferences for receiving real-time and/or scheduled notifications, channel preferences of SMS messages and emails, and conditions for sending notifications.

Step 620 includes receiving an alert trigger message associated with the user identification. For example, notification delivery system 140 may be configured to filter a plurality of events of various alert trigger topics on the data streaming platform to obtain an event of one of the alert trigger topics subscribed for user 165's bank account ending in x1004, as described above for step 420 with reference to FIG. 4. This event may indicate a change in the balance of user 165's bank account.

In some embodiments, the alert trigger message may be a one-time trigger message and contain an alert payload. Before determining whether to send the notification as described below in step 630, notification delivery system 140 may be further configured to determine whether the alert trigger message is valid based on a alert payload of the alert trigger message. For example, as shown in FIG. 5, notification delivery system 140 may be configured to receive a one-time alert for an inadvertent event of not being able to update the balance of user 175's account from the system of record via an API call, as described above in steps 512. A payload of the one-time alert may include user 175's name, identification number, and account number. Notification delivery system 140 may be configured to validate correctness of user 175's name, identification number, and account number in the payload of the one-time alert. If the payload contains correct information, notification delivery system 140 may be configured to determine whether to send a notification, as described below in step 630. If the payload does not contain correct information, notification delivery system 140 may be configured to drop the one-time alert and may not proceed to the operations of step 630.

Step 630 includes determining whether to send the notification based on the alert trigger message and the notification preference profile. For example, after receiving the event indicating the change in the balance of user 165's bank account, notification delivery system 140 may be configured to determine whether to deliver an alert for the event based on the alert trigger message and user's 165 alert preferences. The alert preferences of user 165 may include keeping track of account balances (FIG. 3A). The event, indicating the change in the balance of user 165's bank account, may match user 165's preferences. Because the event may match user 165's alert preferences, notification delivery system 140 may be configured to determine to deliver an alert for the event.

If an event may not match one of the service rule and/or user 165's alert preferences, notification delivery system 140 may be configured to determine to not deliver an alert for the event. For example, if user 165's alert preferences do not include keeping track of account balances, notification delivery system 140 may be configured to determine to not deliver an alert for the event because the event does not match user 165's alert preferences.

In some embodiments, notification delivery system 140 may be configured to determine whether to send the alert notification based on the alert trigger message, the notification preference profile, and a service rule. For example, notification delivery system 140 may be configured to determine whether to deliver an alert for the event based on the alert trigger message, user's 165 alert preferences, and bank system 100's service rules. Bank system 100 may have a service rule that a balance of an account could only be provided to an account owner. Because user 165 is the owner of the account ending in x1004, the event may meet the service rule. In addition, the event, indicating the change in the balance of user 165's bank account, may match user 165's preferences because one of the alert preferences of user 165 is keeping track of account balances (FIG. 3A). Because the event may match the service rules and user 165's alert preferences, notification delivery system 140 may be configured to determine to deliver an alert for the event.

Additionally or alternatively, in some embodiments, a user's notification preference profile may include an alert condition. Notification delivery system 140 may be configured to determine whether to send the notification based on the alert trigger message, the alert condition, and the service rule. For example, user 165's notification preference profile may include a condition that requires an alert when an account balance is lower than $100.00. The alert triggering message for an event may indicate that user 165's account has a balance of $90.00. Notification delivery system 140 may be configured to determine that this event meets the alert condition of a balance below $90,00. In addition, notification delivery system 140 may be configured to determine that user 165's notification preference and the service rule are met as described above. Notification delivery system 140 may therefore determine to send an alert notification to user 165.

Step 640 includes determining whether to send the notification in real time or at a specific time upon determining to send the notification. For example, upon determining to deliver the alert for the event indicating the change in the balance of user 165's bank account, notification delivery system 140 may be configured to determine whether to notify user 165 in real time or at a scheduled time based on user 165's notification preferences profile associated with user 165's account ending in x1004. The notification preference profile, set up by user 165, may include a preference to be notified in real time by an SMS message. Notification delivery system 140 may be configured to determine to send the notification in real time based on the user 165's notification preferences.

Step 650 includes in response to determining to send the notification in real time: generating a real-time alert based on the notification preference profile and sending a real-time notification message based on the real-time alert to a user device associated with the user identification. For example, as shown in FIG. 4, in response to determining to send the notification in real time, notification delivery system 140 may be configured to call an alert delivery application to generate a real-time alert based on user 165's notification preferences. The notification preferences of user 165 may include a subscribed preference to be notified in real time by an SMS message. Notification delivery system 140 may then be configured to call the alert delivery application to generate a real-time alert for an SMS channel. Notification delivery system 140 may also be configured to assemble an SMS message, such as the SMS text in FIG. 3B, based on the real-time alert and an SMS template from alert templates database 405. The SMS template may be associated with the subscribed preference for being notified by an SMS message. Notification delivery system 140 may be further configured to deliver the SMS message to user device 160 of user 165.

In some embodiments, before sending the real-time notification message, notification delivery system 140 may be configured to add the real-time alert to an alert queue, obtain the real-time alert from the alert queue, and generate the real-time notification message based on the real-time alert from the alert queue. For example, as shown in FIG. 4, in response to determining to send the notification in real time, notification delivery system 140 may be configured to call an alert delivery application to generate a real-time alert for an SMS channel based on user 165's notification preferences, as described above in step 650. Notification delivery system 140 may be configured to add the real-time alert for the SMS channel to SMS queue 452, as described above in step 450 with reference to FIG. 4. Notification delivery system 140 may be further configured to dequeue the real-time alert from SMS queue 452 and generate an SMS notification message based on the real-time alert from SMS queue 452, as described above in step 460 with reference to FIG. 4.

Additionally, in some embodiments, the alert queue includes at least one of an email queue, a text message queue, or a push message queue. For example, as shown in FIG. 4, notification delivery system 140 may have the alert queues including one or more of email queue 451, SMS queue 452, and push queue 453. Users 165 and 175 may set up their notification preferences profiles to select at least one of an email channel, an SMS channel, or a push channel to receive one or more notification messages. Thus, users 165's and 175's notification preferences profiles may include a subscribed notification channel. The subscribed notification channel may include at least one of a text message channel, a push channel, or an email channel. When notification delivery system 140 may need to send an alert to user 165 or 175, notification delivery system 140 may be configured to add one or more real-time alerts in email queue 451, SMS queue 452, and push queue 453 and dequeue the one or more real-time alerts therefrom for generating notification messages.

In some embodiments, a user's notification preference profile may include a subscription to an alert trigger topic, and an alert trigger message may be an event message of the alert trigger topic. For example, user 165's notification preference profile may include a subscription to an alert trigger topic about account balances of user 165's bank account ending x1004. Notification delivery system 140 may be configured to receive an alert trigger message for an event related to the alert trigger topic about account balance of user 165's bank account ending in x1004, as described above for step 620 with reference to FIG. 6.

In some embodiments, before determining whether to send an alert notification, notification delivery system 140 may be configured to obtain alert data associated with at least one of the alert trigger topic or the user identification. Notification delivery system 140 may be configured to determine whether to send the notification based on the alert trigger message, the alert data, and the notification preference profile. For example, after receiving the alert trigger message for an event related to the account balances of user 165's bank account, notification delivery system 140 may be configured to obtain alert data associated with the account balances, such as a condition for sending an alert when a balance is below $100.00. Additionally, or alternatively, notification delivery system 140 may be configured to obtain alert data associated with user 165's account ending in x1004, such as the account's setting data indicating that any update to the balance of the account ending in x1004 requires sending an alert message.

Notification delivery system 140 may be configured to determine whether to send the notification based on the alert trigger message, the alert data, and the notification preference profile. When the alert data includes the condition for sending an alert when a balance is below $100.00, notification delivery system 140 may be configured to determine to send the notification because the alert trigger message indicating the balance is $90.00, the condition in the alert data is met, and user 165's notification preference profile indicating a preference of tracking balance update.

As another example, when the alert data includes the account's setting data indicating that any update to the balance of the account ending in x1004 requires to send an alert message, notification delivery system 140 may be configured to determine to send the notification because the alert trigger message indicates that the balance is updated to $90.00, the balance update meets the description of the setting data, and user 165's notification preference profile indicates a preference of tracking balance update.

In some embodiments, after sending the real-time notification message in step 650, notification delivery system 140 may be configured to receive a delivery result indicating a successful delivery or an erroneous delivery, send the delivery result to a data streaming platform when the delivery result indicates the successful delivery, and add the delivery result and the real-time alert to an error queue when the delivery result indicates the erroneous delivery. For example, after sending the SMS message to user device 160 of user 165, notification delivery system 140 may be configured to receive a delivery result indicating a successful delivery or an erroneous delivery. An SMS server may be configured to send the SMS message and return a successful delivery message if the SMS server does not encounter any issues in sending the SMS message. After receiving the successful delivery message, notification delivery system 140 may be configured to publish the successful delivery result, as described above in step 480 with reference to FIG. 4. If the SMS server, for example, detects that the phone number of user 165 is incorrect, the SMS server may return an erroneous delivery message. After receiving the erroneous delivery message, notification delivery system 140 may be configured to add the delivery result and the real-time alert to error queue 475, as described above in step 471 with reference to FIG. 4.

Additionally, or alternatively, in some embodiments, the real-time notification message may be a first real-time notification message. Notification delivery system 140 may be configured to obtain the delivery result and the real-time alert from the error queue, add the real-time alert to the alert queue again, obtain the real-time alert from the alert queue, generate a second real-time notification message based on the real-time alert from the alert queue, and send the second real-time notification message to the user device associated with the user identification. For example, notification delivery system 140 may be configured to dequeue the erroneous delivery result and the real-time alert from error queue 475 for a retry, as described above in step 490 with reference to FIG. 4. Notification delivery system 140 may be configured to add the real-time alert to SMS queue 452 again. Notification delivery system 140 may also be configured to dequeue the real-time alert from SMS queue 452, generate a second SMS message based on the real-time alert, and send the second SMS message to user device 160 associated with user 165's bank account ending in x1004.

In some embodiments, notification delivery system 140 may be configured to obtain the erroneous delivery result and the real-time alert from the error queue for a retry after a predetermined period of time. For example, notification delivery system 140 may be configured to dequeue the erroneous delivery result and the real-time alert from error queue 475 after 5, 10, or 15 minutes.

In some embodiments, notification delivery system 140 may be configured to perform method 600 for delivering a notification for a user account based on one or more of the embodiments and examples described above for the exemplary event-driven notification described above with reference to FIG. 4.

In some embodiments, notification delivery system 140 may be configured to perform method 600 for delivering a notification for a user account based on one or more of the embodiments and examples described above for the exemplary ad hoc API call-driven notification described above with reference to FIG. 5.

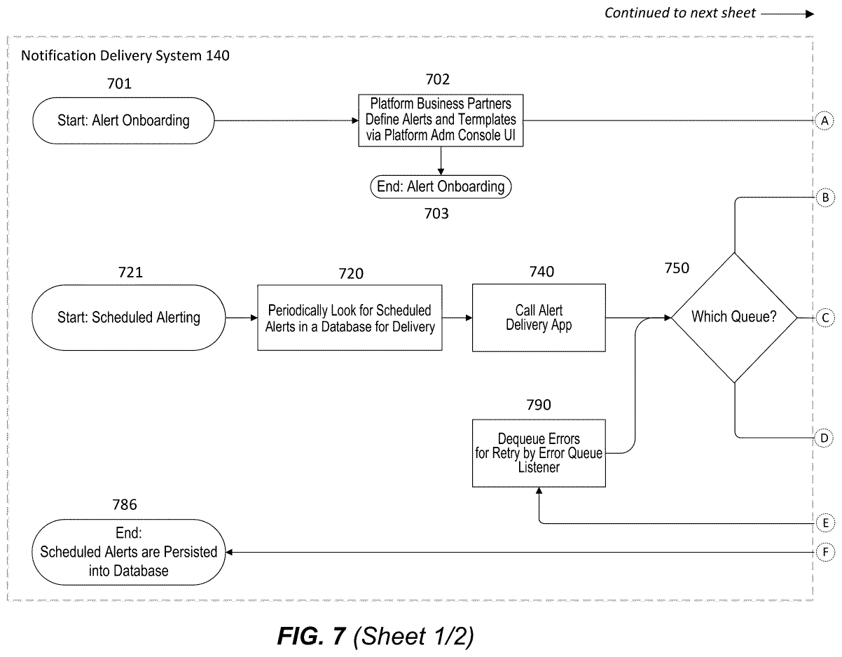

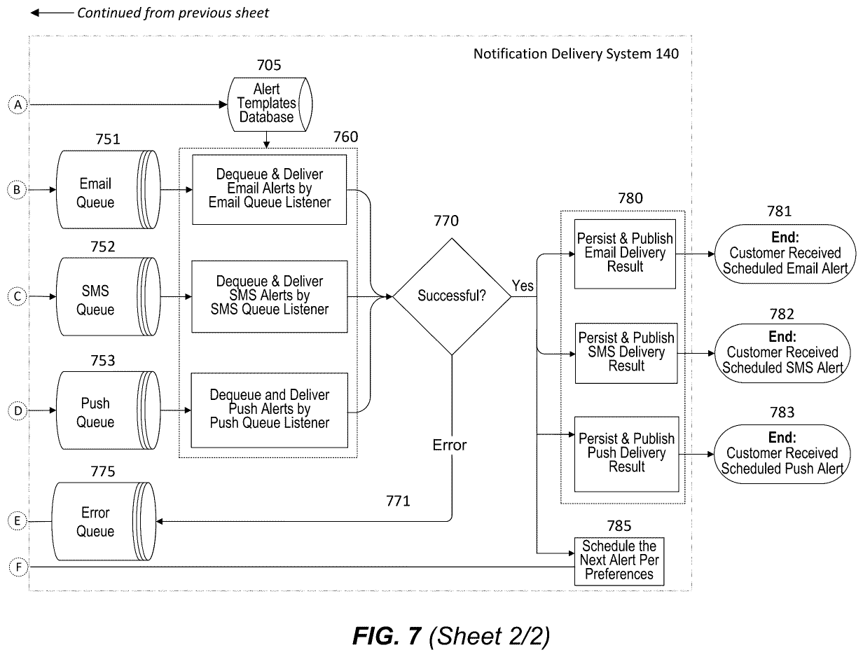

FIG. 7 in two sheets illustrates exemplary operations of an exemplary scheduled notification, consistent with disclosed embodiments. Notification delivery system 140 (FIGS. 2A and 2B) may be configured to practice operations in FIG. 7.

A notification delivery system administrator, for example, a platform business partner, may define alerts and alert templates and configure notification delivery system 140, via an alert administration console user interface (UI) (FIG. 10), to have access to the alert definitions and alert templates. As shown in FIG. 7, notification delivery system 140 may be configured to perform alert onboarding (step 701), configure alert definitions and templates (step 702), and complete alert onboarding (step 703).

Step 701 includes performing an alert onboarding process. For example, notification delivery system 140 may be configured to perform alert onboarding process by receiving alert definitions and alert templates via the alert administration console UI (FIG. 10).

Step 702 includes configuring alert definitions and templates. For example, notification delivery system 140 may be configured to store the alert definitions, business rules for the alert notification, and/or names of notification senders and recipients in alert definitions database 504 (FIG. 5). Notification delivery system 140 may also be configured to store the alert templates in an alert template database 705.

The alert templates may be associated with the alert definitions. In some embodiments, the alert templates may be associated with notification channels, such as SMS, email, and push channels (FIG. 3A).

Step 703 includes completing the alert onboarding process. For example, after storing the alert definitions in alert definition database 504 and the alert templates in alert template database 705, notification delivery system 140 may be configured to end the alert onboarding process.

Alert template database 705 may be implemented by a data storage system and configured to store the alert templates, such as email, SMS, and push message templates.

Notification delivery system 140 may be configured to start a scheduled alerting process (step 721), periodically look for scheduled alerts to be delivered in a database (step 720), call an alert delivery application to generate a scheduled alert (step 740), determine to add the scheduled alert in one of alert queues (step 750), dequeue and deliver the scheduled alert (step 760), determine whether the delivery is successful (step 770), persist and publish a successful delivery result if the delivery is successful (step 780), and end the notification process (steps 781-783). If the delivery is not successful, notification delivery system 140 may be configured to add the scheduled alert in an error queue (step 771) and re-deliver the scheduled alert (step 790). In some embodiments, after determining the delivery is successful in step 770, notification delivery system 140 may be configured to schedule a next scheduled alert per user preferences and end the scheduled alerting process (step 786).

Step 721 includes performing a scheduling alerting process. For example, a scheduled alert on Friday at 8:00 for user 175 may be inserted in a scheduled alert database, as described above for step 531 with reference to FIG. 5. Notification delivery system 140 may be configured to perform a scheduled alerting process for sending an alert notification at a scheduled time.

Step 720 includes periodically looking for scheduled alerts in a database for delivery. For example, notification delivery system 140 may be configured to periodically check a plurality of scheduled alert candidates stored in the scheduled alert database to determine whether any scheduled alerts are to be sent. When the time approaches Friday 8:00, for example, within a time window of 1 minute, notification delivery system 140 may be configured to prepare for sending the scheduled alert.

Step 740 includes calling an alert delivery application to generate a scheduled alert in response to determining to send the scheduled alert. For example, as shown in FIG. 7, in response to determining to send user 175 the scheduled alert on Friday at 8:00, notification delivery system 140 may be configured to call an alert delivery program to generate a scheduled alert based on user 175's notification preference profile. For example, user 175 may set up a notification preference for scheduled alerts by email. Notification delivery system 140 may be configured to generate an email alert.

Step 750 includes determining to add the scheduled alert in one of alert queues. For example, as shown in FIG. 7, notification delivery system 140 may support three alert channels, including the email, SMS, and push channels. Notification delivery system 140 may be configured to establish an email queue 751, an SMS queue 752, and a push queue 753 to keep email alerts, SMS alerts, and push alerts, respectively, before these alerts are delivered. In the example described in step 740, after generating an email alert, notification delivery system 140 may be configured to add the email alert in email queue 751.

Step 760 includes dequeuing and delivering the real-time alert. For example, after adding the email alert in email queue 751, notification delivery system 140 may be configured to dequeue the email alert from email queue 751. Notification delivery system 140 may be configured to assemble an email, similar to the email in FIG. 3D, based on the email alert and the alert templates stored in alert templates database 705. Notification delivery system 140 may be further configured to deliver the email to user 175.

Step 770 includes determining whether the delivery is successful. For example, as shown in FIG. 7, after notification delivery system 140 delivers the email, notification delivery system 140 may be configured to determine whether the delivery is successful based on whether notification delivery system 140 receives an error message. The error message may indicate that the email for the notification was not sent correctly for a reason, such as no response from an email server. If notification delivery system 140 does not receive the error message, notification delivery system 140 may be configured to determine that the delivery is successful. If notification delivery system 140 receives the error message, notification delivery system 140 may be configured to determine that the delivery is not successful.

Step 780 includes persisting and publishing a successful delivery result if the delivery is successful. For example, as shown in FIG. 7, if the delivery is successful, notification delivery system 140 may be configured to persist and publish a successful delivery result in bank system 100. If the delivery is not successful, notification delivery system 140 may be configured to add the delivery result to an error queue 775. As an example, if the email for user 175 is not delivered successfully, notification delivery system 140 may be configured to receive a delivery result indicating an error. Notification delivery system 140 may be configured to add the delivery result of the email for user 175 to error queue 775.

After persisting and publishing the successful delivery result, notification delivery system 140 may be configured to end the notification process for the scheduled alert on Friday at 8:00. For example, notification delivery system 140 may be configured to end the notification process with a record that user 175 has received an email alert (step 781), as shown in FIG. 7.

Step 771 includes adding the email alert in an error queue if the delivery is not successful. For example, if the delivery of the email for user 175 is not successful, notification delivery system 140 may be configured to add the email alert in error queue 775.

Step 790 includes re-delivering the real-time alert. For example, notification delivery system 140 may be configured to dequeue the email alert from error queue 775 and re-deliver the second real-time alert by operations in steps 750, 760, 770, and 780, as described above with reference to FIG. 5.

In some embodiments, after determining the delivery is successful in step 770, notification delivery system 140 may be configured to schedule a next scheduled alert per user preferences (step 785) and end the scheduled alerting process (step 786).

Step 785 includes scheduling a next scheduled alert per user preferences. For example, user 175 may set up preferences to receive the scheduled alert repeatedly until user 175 acknowledges the reception. After the delivery is successful in step 770, notification delivery system 140 may be configured to schedule a next scheduled alert on the next Friday at 8:00 based on user 175′ preferences.

Step 786 includes ending the scheduled alerting process. For example, after scheduling the next scheduled alert, notification delivery system 140 may be configured to complete the scheduled alerting process.

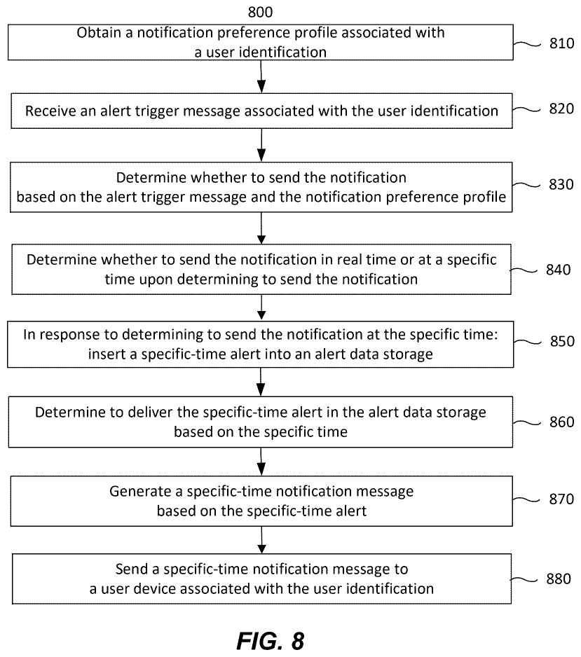

FIG. 8 illustrates an exemplary method 800 for delivering a notification at a specific time, consistent with disclosed embodiments. Notification delivery system 140 may be configured to perform method 800 for delivering a notification for a user account. Method 800 may include obtaining a notification preference profile associated with the user identification (step 810), receiving an alert trigger message associated with the user identification (step 820), determining whether to send the notification based on the alert trigger message and the notification preference profile (step 830), determining whether to send the notification in real time or at a specific time upon determining to send the notification (step 840), in response to determining to send the notification at the specific time: inserting a specific time alert into an alert data storage (step 850), determining to deliver the specific-time alert in the alert data storage based on the specific time (step 860), generating a specific-time alert based on the specific-time alert (step 870), and sending a specific-time notification message to a user device associated with the user identification (step 880).

Step 810 includes obtaining a notification preference profile associated with the user identification. For example, notification delivery system 140 may be configured to obtain user 175's alert preference associated with an account of user 175 from alert preferences database 525 (FIG. 5). User 175's alert preferences may include user-preferred events for sending notifications, preferences for receiving real-time and/or scheduled notifications, channel preferences of SMS messages and emails, and conditions for sending notifications.

Step 820 includes receiving an alert trigger message associated with the user identification. For example, notification delivery system 140 may be configured to filter a plurality of events of various alert trigger topics on the data streaming platform to obtain an event of one of the alert trigger topics subscribed for user 175's bank account, as described above for step 420 with reference to FIG. 4 or step 520 with reference to FIG. 5. The user 175's bank account may be an example of a user identification of user 175. This event may indicate a change in a display mode of user 175's account on online/mobile banking system 110. The display mode of user 175's account on online/mobile banking system 110 may be a layout of a user interface of online/mobile banking system 110.

Step 830 includes determining whether to send the notification based on the alert trigger message and the notification preference profile. For example, after receiving the event indicating the change in the display mode of user 175's account, notification delivery system 140 may be configured to determine whether to deliver an alert for the event based on bank system 100's service rules and user 175's alert preferences. Bank system 100 may have a service rule that a change in a display mode of an account could be provided to the account's owner. Because user 175 is the account owner, the event may meet the service rule. In addition, the event, indicating the change in the display mode of user 175's account, may match user 175's preferences because one of the alert preferences of user 175 may be keeping track of any changes in setting of the account. Because the event may match the service rule and user 175's alert preference, notification delivery system 140 may be configured to determine to deliver an alert for the event.

If an event may not match one of the service rule and/or user 175's alert preferences, notification delivery system 140 may be configured to determine not to deliver an alert for the event. For example, if user 175's alert preferences do not include keeping track of any changes in setting of the account, notification delivery system 140 may be configured to determine not to deliver an alert for the event because the event does not match user 175's alert preferences.

Step 840 includes determining whether to send the notification in real time or at a specific time upon determining to send the notification. For example, upon determining to deliver the alert for the event indicating the change in the display mode of user 175's account, notification delivery system 140 may be configured to determine whether to notify user 175 in real time or at a scheduled time based on user 175's notification preferences profile associated with user 175's account. The notification preference profile, set up by user 175, may include a preference to be notified at a specific time by an email. Notification delivery system 140 may be configured to determine to send the notification at a specific time based on the user 175's notification preferences.

Step 850 includes in response to determining to send the notification at the specific time, inserting a specific time alert into an alert data storage. For example, user 175 may set up an alert about an account setting to be notified at a scheduled time, such as on Friday at 8:00. The notification preference profile, set up by user 175, may include a preference to be notified in a scheduled time of Friday at 8:00 by an email for an account setting event. Notification delivery system 140 may be configured to insert a scheduled alert for Friday at 8:00 in scheduled alert database based on user 175's notification preference profile.

Step 860 includes determining to deliver the specific-time alert in the alert data storage based on the specific time. For example, notification delivery system 140 may be configured to periodically check the scheduled alert database to determine whether any scheduled alerts are to be sent. When the time approaches Friday 8:00, notification delivery system 140 may be configured to determine to deliver the scheduled alert for the change in the display mode of user 175's account.

Step 870 includes generating a specific-time alert based on the specific-time alert. For example, in response to determining to send user 175 the scheduled alert on Friday at 8:00, notification delivery system 140 may be configured to call an alert delivery application program to generate a scheduled alert based on user 175's notification preference profile. Since user 175 may set up a notification preference for scheduled alerts by email, notification delivery system 140 may be configured to generate an email alert.

Step 880 includes sending a specific-time notification message to a user device associated with the user identification. For example, notification delivery system 140 may be configured to dequeue the email alert from email queue 751 (FIG. 7) and assemble an email, similar to the email in FIG. 3D, based on the email alert and the alert templates stored in alert templates database 705. Notification delivery system 140 may be further configured to deliver the email to personal computer 170 of user 175.

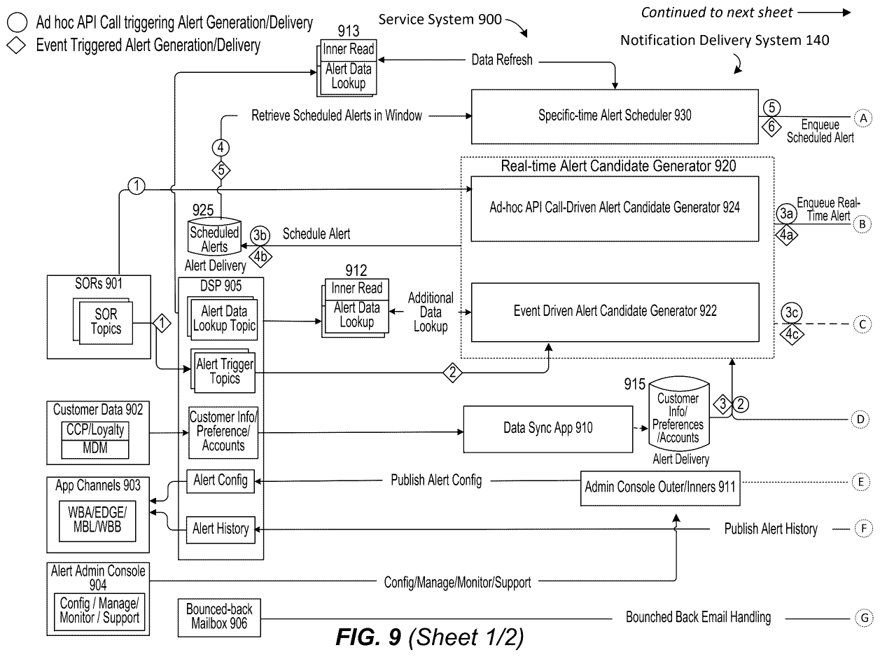

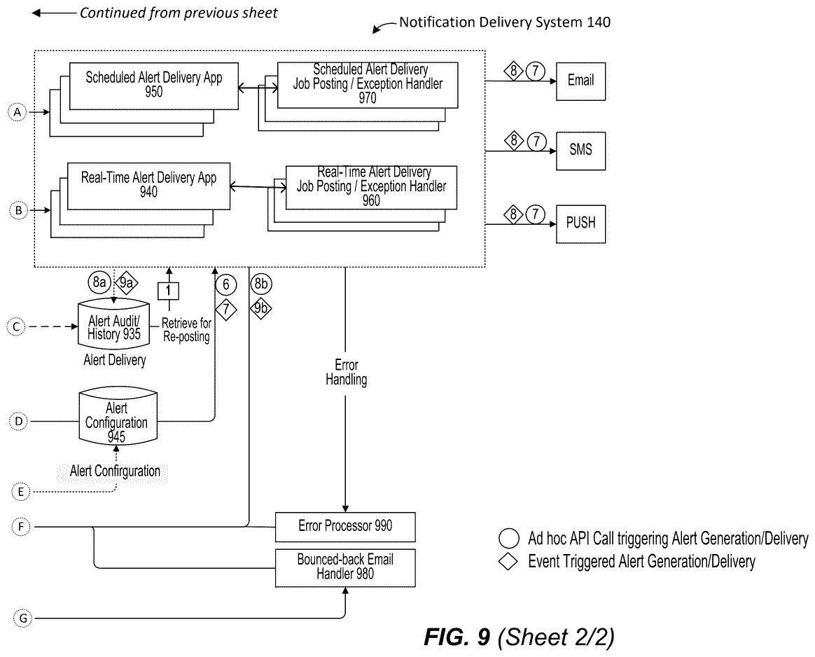

FIG. 9 in two sheets illustrates a functional diagram of an exemplary service system 900 with real-time and scheduled-time notification functions, consistent with disclosed embodiments. Service system 900 may be implemented as bank system 100 by online/mobile banking system 110, core banking system 120, data streaming platform system 130, and notification delivery system 140 (FIG. 2A). As shown in FIG. 9, service system 900 may include a system of record (SOR) 901, customer data 902, channels 903, an administrator console 904, a data streaming platform (DSP) 905, a bounce back mailbox 906, a data synchronization application 910, an administrator console outer/inners 911, alert data lookup processes 912 and 913, a customer information/preferences/accounts database 915, an event-driven alert candidate generator 922, a real-time alert candidate generator 920 including an event-driven alert candidate generator 922 and an ad-hoc API call-driven alert candidate generator 924, a specific-time alert scheduler 930, an alert audit/history database 935, a real-time alert delivery application 940, a configuration store and alert store database 945, a scheduled alert delivery application 950, a real-time alert delivery job posting / exception handler 960, a scheduled alert delivery job posting/exception handler 970, a bounced back email handler 980, and an error processor 990.

System of records (SOR) 901 may be a system, including one or more data storages and one or more processors, configured to record and update service data of user accounts. For example, SOR 901 may be implemented in core banking system 120 (FIG. 2A) to record and update transaction information about all bank accounts when core banking system 210 performs accounting, customer relationship management, risk management, day-to-day transactions, account management, or reporting. When an event about a user account occurs, SOR 901 may be configured to publish the event on DSP 905 if the event is one of a plurality of alert trigger topics. The publication of the event on DSP 905 allows other service applications (e.g., real-time alert candidate generator 920) to receive the event if they subscribe to the one of the plurality of alert trigger topics. Alternatively, if the event is not one of the plurality of alert trigger topics, SOR 901 may be configured to make an ad-hoc API call to real-time alert generator 920 for generating an alert.

Customer data 902 may include a plurality of customer data in service system 900, such as customer information (e.g., names, ages, and occupations), customer alert notification preferences, and customer accounts. In service system 900, customer data may be managed through various interconnected systems, such as a master data management (MDM) system, a central counterparty clearing house (CCP) system, and a customer loyalty system. The MDM system may be configured to manage customer data by providing a centralized repository for customer information. For example, the MDM system may be configured to consolidate customer data from various source systems to establish a unified view of the customer by merging and de-duplicating customer records to ensure that service system 900 has a single, accurate, and trustworthy representation of each customer.

The customer loyalty system may be configured to capture and utilize customer behavior and interactions within loyalty programs. For example, the customer loyalty system may be configured to track data related to customer participation, point accrual, point redemption, and promotional activities. The customer loyalty system may leverage the customer information managed by the MDM system to personalize loyalty programs and enhance customer engagement. The CCP system may be configured to deal with trading and settlement data related to financial transactions like derivatives and equities. For example, the CCP system may be configured to act as intermediaries to guarantee the terms of a trade and become a buyer to every seller and a seller to every buyer to minimize counterparty risk by gathering data related to trade details, such as the type of derivative, contract terms, and collateral deposits.

In some embodiments, customer data 902 may be stored and updated by SOR 901. Service system 900 may be configured to publish customer data 902 on DSP 905, such as customer information, alert notification preferences, and user accounts to allow other applications to obtain these pieces of information.

Application channels 903 may be configured to provide alert configurations and/or alert history to other application systems via a plurality of application channels, such as a web-based application (WBA) channel, an edge computing (EDGE) channel, a member business lending (MBL) channel, a web business banking (WBB) channel.

The WBA channel may be a digital platform accessed through a web browser, to provide interactive functionalities and services to users, functioning as a point of contact or engagement between a business or organization and its customers/users. The EDGE channel may be a channel extending computing capabilities and intelligence closer to data sources, such as ATMs, branches, and customer devices like smartphones. The MBL channel may be a software platform that facilitate credit unions in providing and managing member business loans to their members. The WBB channel may be a banking channel or platform that allows businesses to manage their everyday banking needs through an integrated suite of online, web-based services. The WBB channel may provide a convenient and secure way for companies to access various financial services remotely, such as managing accounts, making payments and transfers, and accessing other relevant information.

Alert administrator console 904 may be an administration application implemented by notification delivery system 140 (FIGS. 2A and 2C) and configured to provide a configuration tool, a delivery management tool, a monitoring and reporting tool, and a customer support tool for users to customize displays of alerts, manage alerts throughout alert delivery processes, review system health and metric reports, and analyze delivered alerts, and notification preferences. In some embodiments, Alert administrator console 904 may be configured to provide the configuration tool, the delivery management tool, the monitoring and reporting tool, and/or the customer support tool to users via an alert admonition console user interface 1000 (FIG. 10).

Data streaming platform (DSP) 905 may be an information publication platform in service system 900. Data streaming platform (DSP) 905 may be implemented by data streaming platform system 130 (FIG. 2A) and configured to publish and exchange various information and data within service system 900 among various applications. For example, DSP 905 may be configured to receive or transmit information and data about alert data lookup topics, alert trigger topics, customer information/preference/accounts, alert configurations, and/or alert history.

Bounced-back mailbox 906 may be implemented by notification delivery system 140 and configured to retain one or more bounced-back emails after notification delivery system 140 transmits alert notification emails. The one or more bounced-back emails may include reasons for being bounced back. The reasons may include that the recipient email address is incorrect or the receiving email server has no response. Notification delivery system 140 may be configured to perform operations of bounced-back email handler 980 to handle the one or more bounced-back emails based on the bounced-back reasons.

Data synchronization application 910 may be implemented by notification delivery system 140 and configured to monitor whether there is any information about customer information, user preferences, user accounts published on DSP 905. When there is an update on the information, data synchronization application 910 may be configured to obtain the information about customers, alert preferences, and/or user accounts and store or update to customer information/preferences/accounts database 915.

Administrator console outer/inners 911 may be implemented by notification delivery system 140 and configured to obtain customers' alert configurations, delivery management instructions, monitoring requests, and support requests from alert administration console 904. Administrator console outer/inners 911 may be configured to publish the customers' alert configurations on DSP 905 for other applications to access. Administrator console outer/inners 911 may also be configured to store the customers' alert configurations into alert configuration database 945.

Alert data lookup process 912 may be implemented by notification delivery system 140 and configured to perform an alert data lookup on relevant alert data lookup topics on DSP 905 for real-time alert candidate generation.

Alert data lookup process 913 may be implemented by notification delivery system 140 (FIG. 2A) and configured to perform an alert data lookup on relevant alert data lookup topics on DSP 905 for scheduled alert candidate generation.

Customer information/preferences/accounts database 915 may include a server with one or more hard drives configured to store customer information, alert preferences, and user accounts. Customer information/preferences/accounts database 915 may also include a database management system to manage its operations and a database application to allow notification delivery system 140 (FIG. 2A) or other systems to interact with customer information/preferences/accounts database 915. Real-time alert candidate generator 920 and/or scheduler application 930 may be configured to access the customer information, alert preferences, and user accounts to generate alert candidates.

Real-time alert candidate generator 920 may be implemented by notification delivery system 140 and configured to generate real-time alert candidates based on events published on DSP 905 and ad-hoc API calls from SOR 901. As shown in FIG. 9, real-time alert candidate generator 920 may include event-driven alert candidate generator 922 and ad-hoc API call-driven alert candidate generator 924.

Event-driven alert candidate generator 922 may be implemented by notification delivery system 140 and configured to generate real-time alert candidates based on the events published on DSP 905 and the customers' alert preferences may be stored in customer information/preferences/accounts database 915.

Ad-hoc API call-driven alert candidate generator 924 may be implemented by notification delivery system 140 and configured to generate real-time alert candidates based on the ad-hoc API calls from SOR 901 and the customers' alert preferences stored in customer information/preferences/accounts database 915.

Scheduled alert database 925 may include a server with one or more hard drives configured to store scheduled alert candidates. Scheduled alert database 925 may also include a database management system to manage its operations and a database application to allow notification delivery system 140 or other systems to interact with scheduled alert database 925.

Specific-time alert scheduler 930 may be implemented by notification delivery system 140 and configured to generate specific-time alert candidates based on either an event published on DSP 905 or an ad-hoc API call from SOR 901, and the customers' alert preferences stored in customer information/preferences/accounts database 915.

Alert audit/history database 935 may include a server with one or more hard drives configured to store real-time alert candidates and alert delivery history. Alert audit/history database 935 may also include a database management system to manage its operations and a database application to allow notification delivery system 140 or other systems to interact with alert audit/history database 935.

Real-time alert delivery application 940 may be implemented by notification delivery system 140 and configured to arrange real-time alert candidates in alert queues and generate real-time alerts based on the real-time alert candidates from the alert queues and alert templates from alert configuration database 945.

Alert configuration database 945 may include a server with one or more hard drives configured to store alert configuration, alert definitions, and alert templates. Alert configuration database 945 may also include a database management system to manage its operations and a database application to allow notification delivery system 140 or other systems to interact with alert configuration database 945.

Scheduled alert delivery application 950 may be implemented by notification delivery system 140 and configured to arrange scheduled alert candidates in alert queues and generate specific-time alerts based on the scheduled alert candidates from the alert queues and alert templates from alert configuration database 945.

Real-time alert delivery job posting/exception handler 960 may be implemented by notification delivery system 140 and configured to deliver the real-time alerts from real-time alert delivery application 940 by posting delivery jobs for message delivery servers to perform alert delivery. The message delivery servers may include email, SMS message, and/or push message servers. If the posted delivery jobs are performed without abnormal signs or error messages, real-time alert delivery job posting/exception handler 960 may be configured to publish the alert delivery history to DSP 905. If any delivery exception or error occurs, real-time alert delivery job posting/exception handler 960 may be configured to provide information about the delivery exception or error to error processor 990.

Scheduled alert delivery job posting/exception handler 970 may be implemented by notification delivery system 140 and configured to deliver the specific-time alerts from scheduled alert delivery application 950 by posting delivery jobs for message delivery servers to perform alert delivery. It is to be understood that handle 960 and handler 970 may be the same or different within the disclosed embodiments. The message delivery servers may include the email, SMS message, and/or push message servers. If the posted delivery jobs are performed without abnormal signs or error messages, scheduled alert delivery job posting/exception handler 960 may be configured to publish alert delivery history to DSP 905. If any delivery exception or error occurs, scheduled alert delivery job posting/exception handler 960 may be configured to provide information about the delivery exception or error to error processor 990.

Bounced-back email handler 980 may be implemented by notification delivery system 140 and configured to analyze the bounced-back emails in bounced-back mailbox 906. The bounced-back emails may be bounced back from an email server after the email server attempts to send an alert email. The bounced-back emails may include reasons for being bounced back, such as an incorrect email address or no response from a receiving email server. Bounced-back email handler 980 may be configured to re-send the alert email or publish delivery history indicating that the incorrect email address on DSP 905.

Error processor 990 may be implemented by notification delivery system 140 and configured to handle an unsuccessful alert delivery. After posting the delivery jobs for the message delivery servers to perform alert delivery, real-time alert delivery job posting/exception handler 960 and/or scheduled alert delivery job posting/exception handler 970 may receive a delivery error message for any reasons, such as an invalid phone number for an SMS text message, an incorrect account number for a pushing message, or no response from the email, SMS message, and/or push message servers. Error processor 990 may be configured to store the alerts for re-delivery or publish delivery history indicating the phone number error on DSP 905.

Service system 900 may be configured to provide services to users 165 and 175, such as banking services or credit points management services. Users 165 and 175 may set up their alert notification preferences on service system 900, as described above with reference to FIGS. 1A-8.

When an event associated with a user identification occurs in service system 900, the event may be associated with alert trigger topics of the user identification. The user identification may be, for example, a user identifier or a user account. A balance change to $90 in user 165's bank account ending in x1004 may be an event (e.g., the balance change to $90) associated with a user identification (e.g., bank account ending in x1004) of user 165. User 165 may set up alert notification preferences including any changes to balances of his or her bank account ending in x1004. That is, alert trigger topics of user 165's bank account ending in x1004 may include any changes to balances of the banking account ending in x1004. Thus, the balance change to $90 is an event associated with the alert trigger topics of user 165's bank account ending in x1004.

When the balance change to $90 occurs, SOR 901 of service system 900 may be configured to detect the event of the balance change associated with one of the alert topics of user 165's bank account ending in x1004. Service system 900 may be configured to perform an event-triggered alert generation and delivery process, as a series of rhombus operations 1-9b shown in FIG. 9. SOR 901 may be configured to publish the event of the change to $90 to the DSP 905 because SOR 901 may be configured to publish all balance updates on DSP 905 to notify other applications. Because the event of the balance change is of one of the alert trigger topics, SOR 901 may be configured to publish the event to the alert trigger topics of DSP 905, as the rhombus operation 1 shown in FIG. 9.

Event-driven alert candidate generator 922 of notification delivery system 140 may be configured to subscribe to the alert trigger topics of user 165's banking account ending in x1004 on DSP 905. When the event is published on DSP 905, event-driven alert candidate generator 922 may be configured to receive the event among a plurality of published events on DSP 905, as the rhombus operation 2 shown in FIG. 9.

Event-driven alert candidate generator 922 may also be configured to retrieve user 165's user information, alert configuration, and alert preferences of the bank account ending in x1004 from customer information/preferences/accounts database 915 and/or from alert configuration database 945, as the rhombus operation 3 shown in FIG. 9. In some embodiments, notification delivery system 140 may also be configured to perform alert data lookup process 912 to look up additional alert data that is published on DSP 905. Event-driven alert candidate generator 922 may be configured to generate a real-time alert candidate based on user 165's user information, alert configuration, alert preferences, and/or the additional alert data.

Event-driven alert candidate generator 922 may be configured to provide the real-time alert candidate to real-time alert delivery application 940 for delivery, as shown in the rhombus operation 4a shown in FIG. 9. Upon receiving the real-time alert candidate, real-time alert delivery application 940 may be configured to enqueue the real-time alert candidate into one or more alert queues, such as email queue 451, SMS queue 452, and push queue 453 (FIG. 4).

In some embodiments, a user may prefer to receive an alert at a scheduled time for an event. The user's preferences may include an indication for this preference. Event-driven alert candidate generator 922 may be configured to retrieve this alert preference from customer information/preferences/accounts database 915. Based on the preference for the scheduled alert, event-driven alert candidate generator 922 may be configured to store a scheduled alert candidate in scheduled alert database 925, as shown in the rhombus operation 4b shown in FIG. 9.

In some embodiments, event-driven alert candidate generator 922 may not successfully call and provide real-time alert delivery application 940 with the real-time alert candidate for delivery. Event-driven alert candidate generator 922 may be configured to store the real-time alert candidate in alert audit/history database 935, as shown in the rhombus operation 4c shown in FIG. 9. Event-driven alert candidate generator 922 may be configured to retrieve the real-time alert candidate from alert audit/history database 935 and provide real-time alert delivery application 940 with the real-time alert candidate again for delivery, as the square operation 1 shown in FIG. 9.

In some embodiments, as described above for the rhombus operation 4b, after the scheduled alert candidate is stored in scheduled alert database 925, specific-time alert scheduler 930 may be configured to retrieve the scheduled alert when its scheduled time is within a time window (e.g., 10 seconds), as shown in the rhombus operation 5 shown in FIG. 9.

In some embodiments, because specific-time alert scheduler 930 may have waited for the scheduled time a while and some alert data may need an update, specific-time alert scheduler 930 may be configured to refresh relevant data by alert data lookup process 913. For example, user 165 may change his or her email address during this waiting period. Specific-time alert scheduler 930 may be configured to update user 165's email address by alert data lookup process 913 to obtain a latest email address from DSP 905.

Additionally, specific-time alert scheduler 930 may be configured to provide the scheduled alert candidate to scheduled alert delivery application 950 for delivery, as shown in the rhombus operation 6 shown in FIG. 9. Upon receiving the scheduled alert candidate, scheduled alert delivery application 950 may be configured to enqueue the scheduled alert candidate into one or more alert queues, such as email queue 751, SMS queue 752, and push queue 753 (FIG. 7).

When the real-time alert candidate in the one or more alert queues becomes the next alert candidate to deliver, real-time alert delivery application 940 may be configured to dequeue the real-time alert candidate from the one or more alert queues. Real-time alert delivery application 940 may also be configured to retrieve, from alert configuration database 945, an alert template corresponding to the real-time alert candidate to create an alert message, as shown in the rhombus operation 7 shown in FIG. 9. For example, if the real-time alert candidate is dequeued from email queue 451 (FIG. 4), real-time alert delivery application 940 may be configured to retrieve an email template from alert configuration database 945 and create an alert email (e.g., the email in FIG. 3D) based on the real-time alert candidate and the email template.

In a similar manner, when the scheduled alert candidate in the one or more alert queues becomes the next alert candidate to deliver, scheduled alert delivery application 950 may be configured to dequeue the scheduled alert candidate from the one or more alert queues. Scheduled alert delivery application 950 may also be configured to retrieve, from alert configuration database 945, an alert template corresponding to the scheduled alert candidate to create an alert message, as shown in the rhombus operation 7 shown in FIG. 9. For example, if the scheduled alert candidate is dequeued from SMS queue 752 (FIG. 7), real-time alert delivery application 950 may be configured to retrieve an SMS text message template from alert configuration database 945 and create an SMS text message (e.g., the SMS text in FIG. 3B) based on the scheduled alert candidate and the SMS text message template.

After real-time alert delivery application 940 creates the alert email, real-time alert delivery job posting/exception handler 960 may be configured to call a downstream alerting service (e.g., an email service from an email server) for delivery, as shown in the rhombus operation 8 shown in FIG. 9. Alternatively or additionally, if real-time alert delivery application 940 creates a push message, real-time alert delivery job posting/exception handler 960 may be configured to call a push message server for delivery.

In a similar manner, after scheduled alert delivery application 950 creates the SMS text message, scheduled alert delivery job posting/exception handler 970 may be configured to call a downstream alerting service (e.g., an SMS text service from an SMS text server) for delivery, as the rhombus operation 8 shown in FIG. 9. Alternatively or additionally, if scheduled alert delivery application 950 creates a push message, scheduled alert delivery job posting/exception handler 970 may be configured to call a push message server for delivery.

After the delivery, real-time alert delivery application 940 and/or scheduled alert delivery application 950 may be configured to store an alert delivery history in alert audit/history 935, as the rhombus operation 9a shown in FIG. 9. In some embodiments, real-time alert delivery application 940 and/or scheduled alert delivery application 950 may also be configured to publish the alert delivery history on DSP 905, as shown in the rhombus operation 9b shown in FIG. 9.

In some embodiments, when an event associated with a user identification occurs in service system 900, the event may be related to the user identification but not associated with alert trigger topics of the user identification. The user identification may be, for example, a user identifier or a user account. For example, user 165 may transfer $100.00 from his or her bank account to user 175's bank account. This transfer may cause a change in the account balance of user 175. Nonetheless, the system of record of bank system 100 may inadvertently encounter an unknown issue and may not be able to update the balance of user 175's bank account. Even though user 175's alert preferences include tracking account balances, such an inadvertent event may not be within the scope of user 175's alert preferences. Notification delivery system 140 may be configured to perform an ad-hoc API call-driven alerting process to alert user 175, as a series of circle operations 1-8b, shown in FIG. 9.

When the inadvertent event occurs, SOR 901 of service system 900 may be configured to detect the event of not being able to update the balance of user 175's bank account. Because the event of not being able to update the balance of user 175's bank account is not one of the alert trigger topics, SOR 901 may be configured to make a one-time API call to ad-hoc API call-driven candidate generator 924 to trigger alert candidate generation, as shown in the circle operation 1 shown in FIG. 9.

Ad-hoc API call-driven alert candidate generator 924 may also be configured to retrieve user 175's user information, alert configuration, and alert preferences of the bank account from customer information/preferences/accounts database 915 and/or from alert configuration database 945, as shown in the circle operation 2 shown in FIG. 9. In some embodiments, notification delivery system 140 may also be configured to perform alert data lookup process 912 to look up additional alert data that is published on DSP 905. Ad-hoc API call-driven alert candidate generator 924 may be configured to generate a real-time alert candidate based on user 175's user information, alert configuration, alert preferences, and/or the additional alert data.

Ad-hoc API call-driven alert candidate generator 924 may be configured to provide the real-time alert candidate to real-time alert delivery application 940 for delivery, as shown in the circle operation 3a shown in FIG. 9. Upon receiving the real-time alert candidate, real-time alert delivery application 940 may be configured to enqueue the real-time alert candidate into one or more alert queues, such as email queue 451, SMS queue 452, and push queue 453 (FIG. 4).

In some embodiments, a user may prefer to receive an alert at a scheduled time for an event. The user's preferences may include an indication for this preference. Ad-hoc API call-driven alert candidate generator 924 may be configured to retrieve this alert preference from customer information/preferences/accounts database 915. Based on the preference for the scheduled alert, ad-hoc API call-driven an alert candidate generator 924 may be configured to store a scheduled alert candidate in scheduled alert database 925, as shown in the circle operation 3b shown in FIG. 9.

In some embodiments, ad-hoc API call-driven alert candidate generator 924 may not successfully call and provide real-time alert delivery application 940 with the real-time alert candidate for delivery. Ad-hoc API call-driven alert candidate generator 924 may be configured to store the real-time alert candidate in alert audit/history database 935, as shown in the circle operation 3c shown in FIG. 9. Ad-hoc API call-driven alert candidate generator 924 may be configured to retrieve the real-time alert candidate from alert audit/history database 935 and provide real-time alert delivery application 940 with the real-time alert candidate again for delivery, as shown in the square operation 1 shown in FIG. 9.

In some embodiments, as described above for the circle operation 3b, after the scheduled alert candidate is stored in scheduled alert database 925, specific-time alert scheduler 930 may be configured to retrieve the scheduled alert when its scheduled time is within a time window (e.g., 10 seconds), as shown in the circle operation 4 shown in FIG. 9.

In some embodiments, because specific-time alert scheduler 930 may have waited for the scheduled time for a while and some alert data may need an update, specific-time alert scheduler 930 may be configured to refresh relevant data by alert data lookup process 913. For example, user 175 (FIG. 2A) may change his or her phone number during the waiting period. Specific-time alert scheduler 930 may be configured to update user 175's phone number by alert data lookup process 913 to obtain a latest phone number from DSP 905.

Additionally, specific-time alert scheduler 930 may be configured to provide the scheduled alert candidate to scheduled alert delivery application 950 for delivery, as shown in the circle operation 5 shown in FIG. 9. Upon receiving the scheduled alert candidate, scheduled alert delivery application 950 may be configured to enqueue the scheduled alert candidate into one or more alert queues, such as email queue 751, SMS queue 752, and push queue 753 (FIG. 7).

When the real-time alert candidate in the one or more alert queues becomes the next alert candidate to be delivered, real-time alert delivery application 940 may be configured to dequeue the real-time alert candidate from the one or more alert queues. Real-time alert delivery application 940 may also be configured to retrieve, from alert configuration database 945, an alert template corresponding to the real-time alert candidate to create an alert message, as shown in the circle operation 6 shown in FIG. 9. For example, if the real-time alert candidate is dequeued from email queue 451 (FIG. 4), real-time alert delivery application 940 may be configured to retrieve an email template from alert configuration database 945 and create an alert email (e.g., the email in FIG. 3D) based on the real-time alert candidate and the email template.

In a similar manner, when the scheduled alert candidate in the one or more alert queues becomes the next alert candidate to deliver, scheduled alert delivery application 950 may be configured to dequeue the scheduled alert candidate from the one or more alert queues. Scheduled alert delivery application 950 may also be configured to retrieve, from alert configuration database 945, an alert template corresponding to the scheduled alert candidate to create an alert message, as shown in the circle operation 6 shown in FIG. 9. For example, if the scheduled alert candidate is dequeued from SMS queue 752 (FIG. 7), real-time alert delivery application 950 may be configured to retrieve an SMS text message template from alert configuration database 945 and create an SMS text message (e.g., the SMS text in FIG. 3B) based on the scheduled alert candidate and the SMS text message template.

After real-time alert delivery application 940 creates the alert email, real-time alert delivery job posting/exception handler 960 may be configured to call a downstream alerting service (e.g., an email service from an email server) for delivery, as shown in the circle operation 7 shown in FIG. 9. Alternatively or additionally, if real-time alert delivery application 940 creates a push message, real-time alert delivery job posting/exception handler 960 may be configured to call a push message server for delivery.

In a similar manner, after scheduled alert delivery application 950 creates the SMS text message, scheduled alert delivery job posting/exception handler 970 may be configured to call a downstream alerting service (e.g., an SMS text service from an SMS text server) for delivery, as shown in the circle operation 7 shown in FIG. 9. Alternatively or additionally, if scheduled alert delivery application 950 creates a push message, scheduled alert delivery job posting/exception handler 970 may be configured to call a push message server for delivery.

After the delivery, real-time alert delivery application 940 and/or scheduled alert delivery application 950 may be configured to store an alert delivery history in alert audit/history 935, as shown in the circle operation 8a shown in FIG. 9. In some embodiments, real-time alert delivery application 940 and/or scheduled alert delivery application 950 may also be configured to publish the alert delivery history on DSP 905, as shown in the circle operation 8b shown in FIG. 9.

If an alert email is delivered, and bounced-back mailbox 906 has a bounced back email, bounced-back email handler 980 may be configured to analyze the bounced-back emails in bounced-back mailbox 906. The bounced-back emails may include reasons for being bounced back, such as an incorrect email address or no response from a receiving email server. If a bounced-back reason is no response from the receiving email server, bounced-back email handler 980 may be configured to re-send the alert email one or more times. If the bounced-back reason is the incorrect email address, bounced-back email handler 980 may be configured to publish delivery history indicating that the incorrect email address on DSP 905.

After posting the delivery jobs for the message delivery servers to perform alert delivery, real-time alert delivery job posting/exception handler 960 and/or scheduled alert delivery job posting/exception handler 970 may receive a delivery error message for any reasons, such as an invalid phone number for an SMS text message, an incorrect account number for a pushing message, or no response from the email, SMS message, and/or push message servers. Error processor 990 may be configured to store the alerts for re-delivery if the delivery error message indicates no response from email, SMS message, and/or push message servers. If the delivery error message indicates an invalid phone number for an SMS text message and/or an incorrect account number for a pushing message, error processor 990 may be configured to publish delivery history indicating that the delivery error on DSP 905. By publishing the delivery history, other applications may obtain this information and could avoid an delivery to the same incorrect phone number or account number.

FIG. 10 is an exemplary alert administration console user interface 1000 of exemplary service system 900, consistent with disclosed embodiments. As shown in FIG. 10, alert administration console UI 1000 may include a configuration tool to customize display of alerts in experience, a delivery management tool to manage alerts thought the alert delivery process, a monitoring and reporting tool to view system health and metric reports. In some embodiments, alert administration console UI 1000 may also include a customer support tool (not shown) to review delivered alerts and customer's preferences. Alert administration console UI 1000 may be a user interface of alert administration console 904 (FIG. 9). Users may enter their user information, alert configuration, and alert preferences to service system 900 via alert administration console UI 1000.

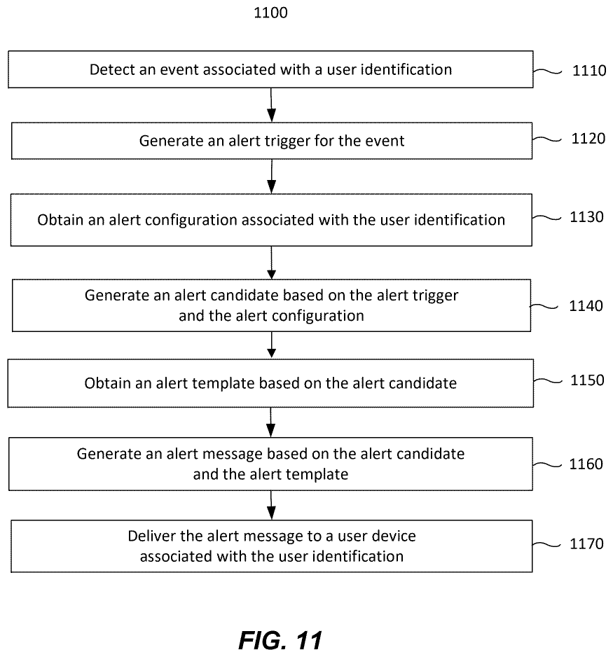

FIG. 11 illustrates an exemplary method 1100 for delivering real-time and scheduled-time notifications by an exemplary service system, consistent with disclosed embodiments. Service system 900 (FIG. 9) may be configured to perform method 1100 for delivering real-time and scheduled-time notifications. Method 1100 may include detecting an event associated with a user identification (step 1110), generating an alert trigger for the event (step 1120), obtaining an alert configuration associated with the user identification (step 1130), generating an alert candidate based on the alert trigger and the alert configuration (step 1140), obtaining an alert template based on the alert candidate (step 1150), generating an alert message based on the alert candidate and the alert template (step 1160), and delivering the alert message to a user device associated with the user identification (step 1170).

Step 1110 includes detecting an event associated with a user identification. For example, as shown in FIG. 9, when a balance change to $90 occurs, SOR 901 of service system 900 may be configured to detect an event of the balance change associated with user 165's bank account ending in x1004. The bank account ending in x1004 may be a user identification of user 165 (FIG. 2A). As another example, when the inadvertent event occurs, SOR 901 of service system 900 may be configured to detect the event of not being able to update the balance of user 175's bank account.

In some embodiments, the user identification may include at least one of a user number or one or more representative characters of a user. For example, the bank account ending in x1004 may be a user number of user 165. As another example, the user identification of user 165 may be user 165's full name or initials, which is one or more representative characters of user 165.

Step 1120 includes generating an alert trigger for the event. For example, because the event of the balance change is of one of the alert trigger topics, SOR 901 may be configured to publish the event to the alert trigger topics of DSP 905, as the rhombus operation 1 shown in FIG. 9. The published event may be an alert trigger for notification delivery system 140 to generate an alert candidate.

In some embodiments, service system 900 may be configured to generate the alert trigger for the event by sending the event to a data streaming platform and filter a plurality of events on the data streaming platform based on the alert configuration associated with the user identification to receive the event. For example, SOR 901 of service system 900 may be configured to publish the event to the alert trigger topics of DSP 905. Event-driven alert candidate generator 922 may be configured to filter a plurality of published events of the alert trigger topics on DSP 905 by using the bank account ending in x1004 to obtain the event of user 165.

In some embodiments, notification delivery system 140 may be configured to generate the alert trigger for the event by sending an application programming interface (API) call message to request generation of the alert candidate. The API call message may include a payload. Notification delivery system 140 may also be configured to analyze the payload of the API call message based on the user identification. For example, because an event of not being able to update the balance of user 175's bank account is not one of the alert trigger topics, SOR 901 may be configured to detect the event and make a one-time API call to ad-hoc API call-driven candidate generator 924 to trigger alert candidate generation, as shown in the circle operation 1 shown in FIG. 9. Ad-hoc API call-driven candidate generator 924 may be configured to analyze a payload of an API call message from SOR 901 based on user 175's account to validate the API call message.

Step 1130 includes obtaining an alert configuration associated with the user identification. For example, as shown in FIG. 9, event-driven alert candidate generator 922 may also be configured to retrieve user 165's alert configuration including user information, alert configuration, and alert preferences of the bank account ending in x1004 from customer information/preferences/accounts database 915 and/or from alert configuration database 945, as the rhombus operation 3 shown in FIG. 9. As another example, as shown in FIG. 9, ad-hoc API call-driven alert candidate generator 924 may be configured to retrieve user 175's alert configuration including user information, alert configuration, and alert preferences of the bank account from customer information/preferences/accounts database 915 and/or from alert configuration database 945, as the circle operation 2 shown in FIG. 9.

In some embodiments, the alert configuration includes a notification preferences profile associated with the user identification. For example, the retrieved user 165's alert configuration includes user information, alert configuration, and alert preferences of the bank account ending in x1004, which may refer to a notification preferences profile of user 165's bank account ending in x1004.

Step 1140 includes generating an alert candidate based on the alert trigger and the alert configuration. For example, as shown in FIG. 9, event-driven alert candidate generator 922 may be configured to generate a real-time alert candidate based on user 165's user information, alert configuration, alert preferences, and/or the additional alert data, and provide the real-time alert candidate to real-time alert delivery application 940 for delivery, as shown in the rhombus operation 4a shown in FIG. 9. As another example, as shown in FIG. 9, ad-hoc API call-driven alert candidate generator 924 may be configured to generate a real-time alert candidate based on user 175's user information, alert configuration, alert preferences, and/or the additional alert data, and provide the real-time alert candidate to real-time alert delivery application 940 for delivery, as shown in the circle operation 3a shown in FIG. 9.

In some embodiments, after event-driven alert candidate generator 922 generates the alert candidate, notification delivery system 140 may be configured to add the alert candidate into an alert delivery queue and obtain the alert candidate from the alert delivery queue when the alert candidate is a front element of the alert delivery queue. For example, event-driven alert candidate generator 922 generates the real-time alert candidate, real-time alert delivery application 940 may be configured to add the real-time alert candidate into email queue 451 (FIG. 4). Real-time alert delivery application 940 may also be configured to obtain the real-time alert candidate from email queue 451 when the real-time alert candidate is a front element of email queue 451 (FIG. 4).

In some embodiments, real-time alert candidate generator 920 may not succeed in adding the alert candidate into the alert delivery queue, real-time alert candidate generator 920 may be configured to save the alert candidate into an alert record storage, obtain the alert candidate from the alert record storage after a condition is satisfied, and add the alert candidate into the alert delivery queue. For example, ad-hoc API call-driven alert candidate generator 924 may not successfully call and provide real-time alert delivery application 940 with the real-time alert candidate for delivery. Ad-hoc API call-driven alert candidate generator 924 may be configured to store the real-time alert candidate in alert audit/history database 935, as shown in the circle operation 3c shown in FIG. 9. After a predetermined condition (e.g., after 1 minute) is satisfied, ad-hoc API call-driven alert candidate generator 924 may be configured to retrieve the real-time alert candidate from alert audit/history database 935 and provide real-time alert delivery application 940 with the real-time alert candidate again to add into, for example, email queue 451 (FIG. 4), as shown in the square operation 1 shown in FIG. 9.

In some embodiments, after generating the alert candidate, notification delivery system 140 may be configured to save the alert candidate into a specific-time alert data storage. The alert candidate may include a specific time. Notification delivery system 140 may also be configured to obtain the alert candidate from the specific-time alert data storage when a current time is within a time window from the specific time.

For example, a user may prefer to receive an alert at a scheduled time for an event. The user's preferences may include an indication for this preference. Event-driven alert candidate generator 922 may be configured to retrieve this alert preference from customer information/preferences/accounts database 915 and generate and store a scheduled alert candidate in scheduled alert database 925 based on the preference for the scheduled alert, as shown in the rhombus operation 4b shown in FIG. 9. Specific-time alert scheduler 930 may be configured to retrieve the scheduled alert candidate when its scheduled time is within a time window (e.g., 10 seconds), as shown in the rhombus operation 5 shown in FIG. 9.

Step 1150 includes obtaining an alert template based on the alert candidate. For example, real-time alert delivery application 940 may be configured to retrieve the email template from alert configuration database 945 and create an alert email (e.g., the email in FIG. 3D) based on the real-time alert candidate and the email template, as shown in the rhombus operation 7 shown in FIG. 9. As another example, real-time alert delivery application 940 may be configured to retrieve, from alert configuration database 945, the alert template corresponding to the real-time alert candidate to create an alert message, as shown in the circle operation 6 shown in FIG. 9.

Step 1160 includes generating an alert message based on the alert candidate and the alert template. For example, real-time alert delivery application 940 may also be configured to retrieve an email template from alert configuration database 945 and create an alert email (e.g., the email in FIG. 3D) based on the real-time alert candidate and the email template, as shown in the rhombus operation 7 shown in FIG. 9.

Step 1170 includes delivering the alert message to a user device associated with the user identification. For example, after real-time alert delivery application 940 creates the alert email, real-time alert delivery job posting/exception handler 960 may be configured to call an email server to deliver the alert email, as shown in the rhombus operation 8 shown in FIG. 9. User 175 (FIG. 2) may receive the alert email on his user device 170. Alternatively, if real-time alert delivery application 940 creates a push message, real-time alert delivery job posting/exception handler 960 may be configured to call a push message server to deliver the push message. User 165 (FIG. 2A) may receive the push message by a service system 900's application on his user device 160.

After delivering the alert message, notification delivery system 140 may be further configured to save an alert history of the event in an alert record storage and send the alert history of the event to a data streaming platform. For example, after the delivery, real-time alert delivery application 940 and/or scheduled alert delivery application 950 may be configured to store an alert delivery history in alert audit/history 935, as shown in the rhombus operation 9a shown in FIG. 9. Real-time alert delivery application 940 and/or scheduled alert delivery application 950 may also be configured to publish the alert delivery history on DSP 905, as the rhombus operation 9b shown in FIG. 9.

In some embodiments, notification delivery system 140 may be configured to receive an unsuccessful message about delivery of the alert message and send an alert history for the event to a data streaming platform. For example, after posting the delivery jobs for the message delivery servers to perform alert delivery, real-time alert delivery job posting/exception handler 960 and/or scheduled alert delivery job posting/exception handler 970 may receive a delivery error message because of an invalid phone number for an SMS text message. Error processor 990 may be configured to publish delivery history indicating the phone number error on DSP 905.

In some embodiments, the alert message may be an alert email. Notification delivery system 140 may be configured to receive a bounced back email about delivery of the alert email and send an alert history for the event to a data streaming platform. For example, an alert message for the balance change to user 165's bank account may be an email. After the delivery, service system 900 may receive a bounced-back email in bounced-back mailbox 906. Bounced-back email handler 980 may be configured to analyze the reason for being bounced back, which may be, for example, an invalid email address. Bounced-back email handler 980 may be configured to send an alert history indicating the bounced-back email because of the invalid email address on DSP 905.

The systems and methods for delivering an alert notification in real time may enhance bank system 100 to provide timely notification to a user. When an event, an issue, or an error occurs in a user transaction or a user account, the systems and methods may be configured to notify the user in real time by the user's preferred SMS text message, email and/or push message in a mobile application. These systems and methods may improve the security of bank system 100 or the user's account and privacy. They may also improve the user's experience with bank system 100.

Another aspect of the disclosure is directed to a non-transitory computer-readable medium storing instructions which, when executed, cause one or more computers to perform the methods discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

1. A system for delivering a notification for a user identification, the system comprising:
a memory storing a plurality of instructions; and
at least one processor in electronic communication with the memory, the at least one processor configured to execute the plurality of instructions to:
obtain a notification preference profile associated with the user identification;
receive an alert trigger message associated with the user identification;
determine whether to send the notification based on the alert trigger message and the notification preference profile;
upon determining to send the notification, determine whether to send the notification in real time or at a specific time; and
in response to determining to send the notification in real time:
generate a real-time alert based on the notification preference profile; and
send a real-time notification message based on the real-time alert to a user device associated with the user identification.

2. The system of claim 1, wherein the at least one processor is configured to determine whether to send the notification based on the alert trigger message, the notification preference profile, and a service rule.

3. The system of claim 2, wherein the notification preference profile includes an alert condition, and the at least one processor is configured to:
determine whether to send the notification based on the alert trigger message, the alert condition, and the service rule.

4. The system of claim 1, wherein before sending the real-time notification message, the at least one processor is further configured to:
add the real-time alert to an alert queue;
obtain the real-time alert from the alert queue; and
generate the real-time notification message based on the real-time alert from the alert queue.

5. The system of claim 4, wherein the alert queue includes at least one of an email queue, a text message queue, or a push message queue.

6. The system of claim 1, wherein the at least one processor is configured to generate the real-time notification message based on the notification preference profile and a notification template.

7. The system of claim 6, wherein the notification preference profile includes a subscribed notification channel, and the notification template is associated with the subscribed notification channel.

8. The system of claim 5, wherein after sending the real-time notification message, the at least one processor is further configured to:
receive a delivery result indicating a successful delivery or an erroneous delivery;
send the delivery result to a data streaming platform when the delivery result indicates the successful delivery; and
add the delivery result and the real-time alert to an error queue when the delivery result indicates the erroneous delivery.

9. The system of claim 8, wherein the real-time notification message is a first real-time notification message, and the at least one processor is further configured to:
obtain the delivery result and the real-time alert from the error queue;
add the real-time alert to the alert queue;
obtain the real-time alert from the alert queue;
generate a second real-time notification message based on the real-time alert from the alert queue; and
send the second real-time notification message to the user device associated with the user identification.

10. The system of claim 9, wherein the at least one processor is configured to obtain the delivery result and the real-time alert from the error queue after a predetermined period of time.

11. The system of claim 1, wherein the notification preference profile includes a subscribed notification channel, wherein the subscribed notification channel includes at least one of a text message channel, a push channel, or an email channel.

12. The system of claim 1, wherein the notification preference profile includes a subscription to an alert trigger topic, and the alert trigger message is an event message of the alert trigger topic.

13. The system of claim 12, wherein before determining whether to send the notification, the at least one processor is further configured to:
obtain alert data associated with at least one of the alert trigger topic or the user identification,
wherein the at least one processor is configured to determine whether to send the notification based on the alert trigger message, the alert data, and the notification preference profile.

14. The system of claim 1, wherein:
the alert trigger message is a one-time trigger message and contains an alert payload; and
before determining whether to send the notification, the at least one processor is further configured to determine that the alert trigger message is associated with the user identification based on the alert payload.

15. A method for delivering notification for a user identification, the method comprising:
obtaining a notification preference profile associated with the user identification;
receiving an alert trigger message associated with the user identification;
determining whether to send the notification based on the alert trigger message and the notification preference profile;
upon determining to send the notification, determining whether to send the notification in real time or at a specific time; and
in response to determining to send the notification in real time:
generating a real-time alert based on the notification preference profile; and
sending a real-time notification message based on the real-time alert to a user device associated with the user identification.

16. The method of claim 15, wherein before sending the real-time notification message, the method further comprises:
adding the real-time alert to an alert queue;
obtaining the real-time alert from the alert queue; and
generating the real-time notification message based on the real-time alert from the alert queue.

17. The method of claim 15, wherein after sending the real-time notification message, the method further comprises:
receiving a delivery result indicating a successful delivery or an erroneous delivery;
sending the delivery result to a data streaming platform when the delivery result indicates the successful delivery; and
adding the delivery result and the real-time alert to an error queue when the delivery result indicates the erroneous delivery.

18. A non-transitory computer-readable medium storing instructions which, when executed, cause at least one processor to perform operations for delivering notification for a user identification, the operations comprising:
obtaining a notification preference profile associated with the user identification;
receiving an alert trigger message associated with the user identification;
determining whether to send the notification based on the alert trigger message and the notification preference profile;
upon determining to send the notification, determining whether to send the notification in real time or at a specific time; and
in response to determining to send the notification in real time:
generating a real-time alert based on the notification preference profile; and
sending a real-time notification message based on the real-time alert to a user device associated with the user identification.

19. The non-transitory computer-readable medium of claim 18, wherein before sending the real-time notification message, the operations further comprise:
adding the real-time alert to an alert queue;
obtaining the real-time alert from the alert queue; and
generating the real-time notification message based on the real-time alert from the alert queue.

20. The non-transitory computer-readable medium of claim 18, wherein after sending the real-time notification message, the operations further comprise:
receiving a delivery result indicating a successful delivery or an erroneous delivery;
sending the delivery result to a data streaming platform when the delivery result indicates the successful delivery; and
adding the delivery result and the real-time alert to an error queue when the delivery result indicates the erroneous delivery.

21.-60. (canceled)
